(19) United States
(12) Patent Application Publication
(10) Pub. No.: US 2024/0256710 A1
(43) Pub. Date: Aug. 1, 2024

(54) INFORMATION PROCESSING SYSTEM, INFORMATION PROCESSING APPARATUS, INFORMATION PROCESSING METHOD, AND RECORDING MEDIUM

(71) Applicant: NEC Corporation, Minato-ku, Tokyo (JP)

(72) Inventor: Yoshinori Koda, Tokyo (JP)

(73) Assignee: NEC Corporation, Minato-ku, Tokyo (JP)

(21) Appl. No.: 18/292,546

(22) PCT Filed: Aug. 6, 2021
(86) PCT No.: PCT/JP2021/029416

§ 371 Date: Jan. 26, 2024

(51) Int. Cl. G06F 21/62; G06F 21/32; G10L 15/26

(52) U.S. Cl. CPC G06F 21/6254; G06F 21/32; G10L 15/26

(57) ABSTRACT

An information processing system includes: an acquisition unit that obtains conversation data including speech information on a plurality of people; a textualization unit that converts into text the speech information in the conversation data; a confidential information acquisition unit that obtains information about a confidential target included in the conversation data; and a concealment unit that conceals a part of text of the conversation data on the basis of the information about the confidential target. According to such an information processing system, it is possible to properly conceal a part of the conversation data.

### TECHNICAL FIELD

This disclosure relates to technical fields of an information processing system, an information processing apparatus, an information processing method, and a recording medium.

### BACKGROUND ART

A known system of this type conceals (e.g., encrypts, etc.) a part of speech data. For example, Patent Literature 1 discloses a technology/technique of encrypting speech data inputted from a microphone. Patent Literature 2 discloses a technology/technique of encrypting inputted speech data with an encryption key and generating an encrypted audio file. Patent Literature 3 discloses a technology/technique of masking a designated spot in the speech data.

### CITATION LIST

### Patent Literature

Patent Literature 1: JP2020-123204A
Patent Literature 2: JP2010-074391A
Patent Literature 3: JP2009-501942A

### SUMMARY

### Technical Problem

This disclosure aims to improve the techniques/technologies disclosed in Citation List.

### Solution to Problem

An information processing system according to an example aspect of this disclosure includes: an acquisition unit that obtains conversation data including speech information on a plurality of people: a textualization unit that converts into text the speech information in the conversation data: a confidential information acquisition unit that obtains information about a confidential target included in the conversation data; and a concealment unit that conceals a part of text of the conversation data on the basis of the information about the confidential target.

An information processing apparatus according to an example aspect of this disclosure includes: an acquisition unit that obtains conversation data including speech information on a plurality of people: a textualization unit that converts into text the speech information in the conversation data: a confidential information acquisition unit that obtains information about a confidential target included in the conversation data; and a concealment unit that conceals a part of text of the conversation data on the basis of the information about the confidential target.

An information processing method according to an example aspect of this disclosure is an information processing method executed by at least one computer, the information processing method including: obtaining conversation data including speech information on a plurality of people: converting into text the speech information in the conversation data: obtaining information about a confidential target included in the conversation data; and concealing a part of text of the conversation data on the basis of the information about the confidential target.

A recording medium according to an example aspect of this disclosure is a recording medium on which a computer program that allows at least one computer to execute an information processing method is recorded, the information processing method including: obtaining conversation data including speech information on a plurality of people: converting into text the speech information in the conversation data: obtaining information about a confidential target included in the conversation data; and concealing a part of text of the conversation data on the basis of the information about the confidential target.

### BRIEF DESCRIPTION OF DRAWINGS

FIG. 1 is a block diagram illustrating a hardware configuration of an information processing system according to a first example embodiment.

FIG. 2 is a block diagram illustrating a functional configuration of the information processing system according to the first example embodiment.

FIG. 3 is a flowchart illustrating a flow of a concealment operation by the information processing system according to the first example embodiment.

FIG. 4 is a block diagram illustrating a functional configuration of an information processing system according to a second example embodiment.

FIG. 5 is a flowchart illustrating a flow of the concealment operation by the information processing system according to the second example embodiment.

FIG. 6 is a conceptual diagram illustrating a specific example of speaker classification by the information processing system according to the second example embodiment.

FIG. 7 is a conceptual diagram illustrating a specific example of concealment by the information processing system according to the second example embodiment.

FIG. 8 is a plan view illustrating a first display example when a confidential target is set by an information processing system according to a third example embodiment.

FIG. 9 is a plan view illustrating a second display example when the confidential target is set by the information processing system according to the third example embodiment.

FIG. 10 is a plan view illustrating a third display example when the confidential target is set by the information processing system according to the third example embodiment.

FIG. 11 is a block diagram illustrating a functional configuration of an information processing system according to a fourth example embodiment.

FIG. 12 is a flowchart illustrating a flow of the concealment operation by the information processing system according to the fourth example embodiment.

FIG. 13 is a flowchart illustrating a flow of a concealment cancel operation by the information processing system according to the fourth example embodiment.

FIG. 14 is a block diagram illustrating a functional configuration of an information processing system according to a fifth example embodiment.

FIG. 15 is a flowchart illustrating a flow of the concealment cancel operation by the information processing system according to the fifth example embodiment.

FIG. 16 is a table illustrating a correlation between a concealment level and a browse level in the information processing system according to the fifth example embodiment.

FIG. 17 is a plan view illustrating a display example when the concealment level is set by the information processing system according to the fifth example embodiment.

FIG. 18 is a block diagram illustrating a functional configuration of an information processing system according to a sixth example embodiment.

FIG. 19 is a flowchart illustrating a flow of the concealment operation by the information processing system according to the sixth example embodiment.

FIG. 20A to FIG. 20C are conceptual diagrams illustrating specific examples of the concealment by the information processing system according to the sixth example embodiment.

FIG. 21 is a block diagram illustrating a functional configuration of an information processing system according to a seventh example embodiment.

FIG. 22 is a flow chart illustrating a flow of a confidential target information acquisition operation by the information processing system according to the seventh example embodiment.

FIG. 23 is a block diagram illustrating a functional configuration of an information processing system according to an eighth example embodiment.

FIG. 24 is a flow chart illustrating a flow of the confidential target information acquisition operation by the information processing system according to the eighth example embodiment.

FIG. 25 is a plan view illustrating a display example of an operation terminal by the information processing system according to the eighth example embodiment.

FIG. 26 is a block diagram illustrating a functional configuration of an information processing system according to a ninth example embodiment.

FIG. 27 is a flowchart illustrating a flow of a confidential part change operation by the information processing system according to the ninth example embodiment.

FIG. 28 is version 1 of a conceptual diagram illustrating an example of change in a display aspect by the information processing system according to the ninth example embodiment.

FIG. 29 is version 2 of a conceptual diagram illustrating an example of change in the display aspect by the information processing system according to the ninth example embodiment.

FIG. 30 is a block diagram illustrating a functional configuration of an information processing system according to a tenth example embodiment.

FIG. 31 is a block diagram illustrating a functional configuration of an information processing system according to an eleventh example embodiment.

FIG. 32 is a block diagram illustrating a functional configuration of an information processing system according to a twelfth example embodiment.

### DESCRIPTION OF EXAMPLE EMBODIMENTS

Hereinafter, an information processing system, an information processing method, and a recording medium according to example embodiments will be described with reference to the drawings.

### First Example Embodiment

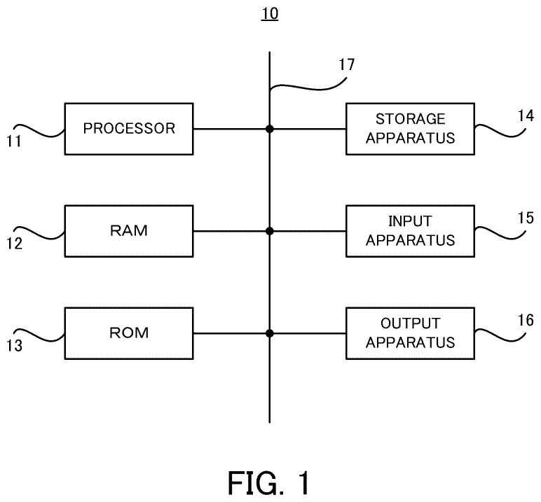

An information processing system according to a first example embodiment will be described with reference to FIG. 1 to FIG. 3.

### (Hardware Configuration)

First, a hardware configuration of the information processing system according to the first example embodiment will be described with reference to FIG. 1. FIG. 1 is a block diagram illustrating the hardware configuration of the information processing system according to the first example embodiment.

As illustrated in FIG. 1, an information processing system 10 according to the first example embodiment includes a processor 11, a RAM (Random Access Memory) 12, a ROM (Read Only Memory) 13, and a storage apparatus 14. The information processing system 10 may further include an input apparatus 15 and an output apparatus 16. The processor 11, the RAM 12, the ROM 13, the storage apparatus 14, the input apparatus 15, and the output apparatus 16 are connected through a data bus 17.

The processor 11 reads a computer program. For example, the processor 11 is configured to read a computer program stored by at least one of the RAM 12, the ROM 13 and the storage apparatus 14. Alternatively, the processor 11 may read a computer program stored in a computer-readable recording medium by using a not-illustrated recording medium reading apparatus. The processor 11 may obtain (i.e., may read) a computer program from a not-illustrated apparatus disposed outside the information processing system 10, through a network interface. The processor 11 controls the RAM 12, the storage apparatus 14, the input apparatus 15, and the output apparatus 16 by executing the read computer program. Especially in this example embodiment, when the processor 11 executes the read computer program, a functional block for concealing a part of conversation data is realized or implemented in the processor 11.

The processor 11 may be configured as, for example, a CPU (Central Processing Unit), a GPU (Graphics Processing Unit), a FPGA (field-programmable gate array), a DSP (Demand-Side Platform) or an ASIC (Application Specific Integrated Circuit). The processor 11 may be one of them, or may use a plurality of them in parallel.

The RAM 12 temporarily stores the computer program to be executed by the processor 11. The RAM 12 temporarily stores the data that are temporarily used by the processor 11 when the processor 11 executes the computer program. The RAM 12 may be, for example, a D-RAM (Dynamic RAM).

The ROM 13 stores the computer program to be executed by the processor 11. The ROM 13 may otherwise store fixed data. The ROM 13 may be, for example, a P-ROM (Programmable ROM).

The storage apparatus 14 stores the data that are stored for a long term by the information processing system 10. The storage apparatus 14 may operate as a temporary storage apparatus of the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the information processing system 10. The input apparatus 15 may include, for example, at least one of a keyboard, a mouse, and a touch panel. The input apparatus 15 may be configured as a portable terminal such as a smartphone or a tablet.

The output apparatus 16 is an apparatus that outputs information about the information processing system 10 to the outside. For example, the output apparatus 16 may be a display apparatus (e.g., a display) that is configured to display the information about the information processing system 10. The output apparatus 16 may be a speaker device or the like that is configured to audio-output the information about the information processing system 10. The output apparatus 16 may be configured as a portable terminal such as a smartphone or a tablet.

Although FIG. 1 illustrates the information processing system 10 including a plurality of apparatuses, all or a part of the functions thereof may be realized in a single apparatus (information processing apparatus). The information processing apparatus may include only the processor 11, the RAM12, and the ROM13, for example, and an external apparatus connected to the information processing apparatus may include the other components (i.e., the storage apparatus 14, the input apparatus 15, and the output apparatus 16), for example. In the information processing apparatus, a part of an arithmetic function may also be realized by an external apparatus (e.g., an external server or cloud).

### (Functional Configuration)

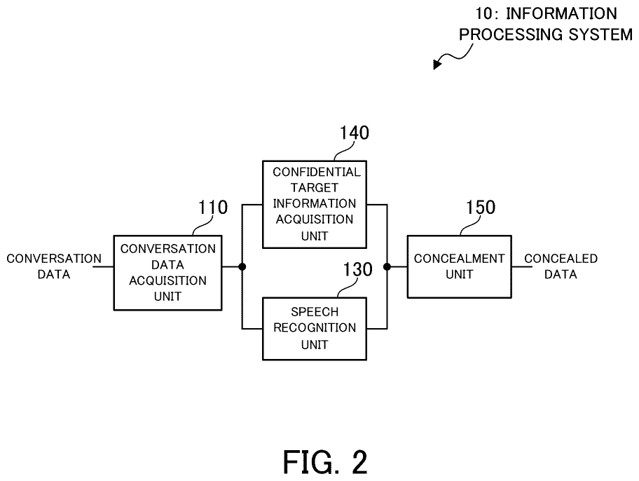

Next, a functional configuration of the information processing system 10 according to the first example embodiment will be described with reference to FIG. 2. FIG. 2 is a block diagram illustrating the functional configuration of the information processing system according to the first example embodiment.

As illustrated in FIG. 2, the information processing system 10 according to the first example embodiment includes, as components for realizing the functions thereof, a conversation data acquisition unit 110, a speech recognition unit 130, a confidential target information acquisition unit 140, and a concealment unit 150. Each of the conversation data acquisition unit 110, the speech recognition unit 130, the confidential target information acquisition unit 140, and the concealment unit 150 may be a processing block realized or implemented by the processor 11 (see FIG. 1), for example.

The conversation data acquisition unit 110 obtains conversation data including speech information on a plurality of people. The conversation data acquisition unit 110 may directly obtain the conversation data from a microphone or the like, or may obtain the conversation data generated by another apparatus or the like, for example. An example of the conversation data includes meeting data obtained by recording a speech/voice at a meeting/conference, or the like. The conversation data acquisition unit 110 may be configured to perform various processes on the obtained conversation data. For example, the conversation data acquisition unit 110 may be configured to perform a process of detecting a speaker speaking section of the conversation data.

The speech recognition unit 130 performs a process of converting the speech information in the conversation data into text (hereinafter referred to as a “speech recognition process”). The speech recognition process may be a process performed when utterance/speaking is started (e.g., a process of outputting text while following the utterance/speaking), or may be a process performed after the utterance/speaking is ended (e.g., a process performed on past recorded data). A detailed description of a specific technology/technique of the speech recognition process will be omitted here, because the existing technologies/techniques may be adopted to the process as appropriate.

The confidential target information acquisition unit 140 is configured to obtain information about a confidential target included in the conversation data (hereinafter referred to as “confidential target information” as appropriate). The confidential target information is information indicating a spot to be concealed in the conversation data. The confidential target information may include information for identifying a person (i.e., a speaker) for whom a conversation is concealed, for example. The confidential target information may also include information for identifying a word, a sentence, or the like to be concealed. A specific method of obtaining the confidential target information will be described in detail in another example embodiment later.

The concealment unit 150 is configured to perform a process of concealing a part of the text of the conversation data (hereinafter referred to as a “concealment process”), on the basis of the confidential target information obtained by the confidential target information acquisition unit 140. Specifically; the concealment unit 150 performs a process of setting the spot to be concealed, which is indicated by the confidential target information, to be not browsable. A specific aspect of the concealment process will be described in detail later. The concealment unit 150 may have a function of outputting text data in which a part of the conversation data is concealed (hereinafter referred to as “confidential data” as appropriate). For example, the concealment unit 150 may display the confidential data on a display or the like.

### (Concealment Operation)

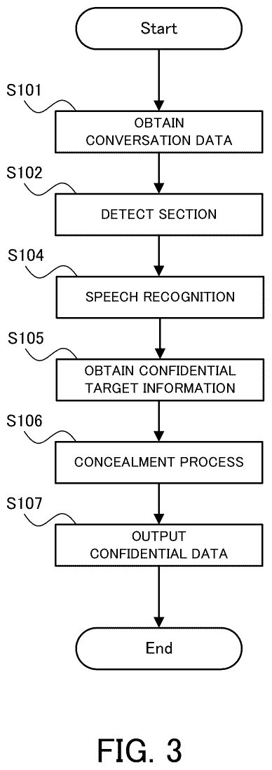

Next, a flow of an operation when a part of the conversation data is concealed (hereinafter, appropriately referred to as a “concealment operation”) by the information processing system 10 according to the first example embodiment will be described with reference to FIG. 3. FIG. 3 is a flowchart illustrating a flow of the concealment operation by the information processing system according to the first example embodiment.

As illustrated in FIG. 3, in the concealment operation by the information processing system 10 according to the first example embodiment, first, the conversation data acquisition unit 110 obtains the conversation data including the speech information on a plurality of people (step S101). Then, the conversation data acquisition unit 110 performs the process of detecting the speaker speaking section of the conversation data (hereinafter referred to as a “section detection process” as appropriate) (step S102). The section detection process may be, for example, a process of detecting and trimming a silent section.

Subsequently, the speech recognition unit 130 performs the speech recognition process on the conversation data on which the section detection process is performed (step S104).

Subsequently, the confidential target information acquisition unit 140 obtains the confidential target information (step S105). Then, on the basis of the confidential target information obtained by the confidential target information acquisition unit 140, the concealment unit 150 conceals a part of the conversation data that are converted into text or that are textualized (step S106). After that, the concealment unit 150 outputs the confidential data (step S107).

The confidential target information may be obtained at any timing, such as when the conversation is started, during the conversation, or when the conversation is ended. When the confidential target information is obtained after the conversation is started, the concealment unit 150 may perform the concealment process on the content of the conversation after the confidential target information is obtained. Alternatively, the concealment unit 150 may perform the concealment process, retrospectively from before the confidential target information is obtained (e.g., from a timing when the conversation is started).

### (Technical Effect)

Next, a technical effect obtained by the information processing system 10 according to the first example embodiment will be described.

As described in FIG. 1 to FIG. 3, in the information processing system 10 according to the first example embodiment, a part of the textualized conversation data is concealed. In this way, it is possible to properly conceal a part of information included in the conversation data. Therefore, while disclosing a part of the conversation data (i.e., a part that may be known), it is possible to conceal the other part (i.e., a part that one does not want to be known to others). As a result, it is possible to properly prevent information leakage from the conversation data. The above-described technical effect is significantly exhibited in the case of keeping a record of an in-house meeting of high confidentiality, or the like, for example.

### Second Example Embodiment

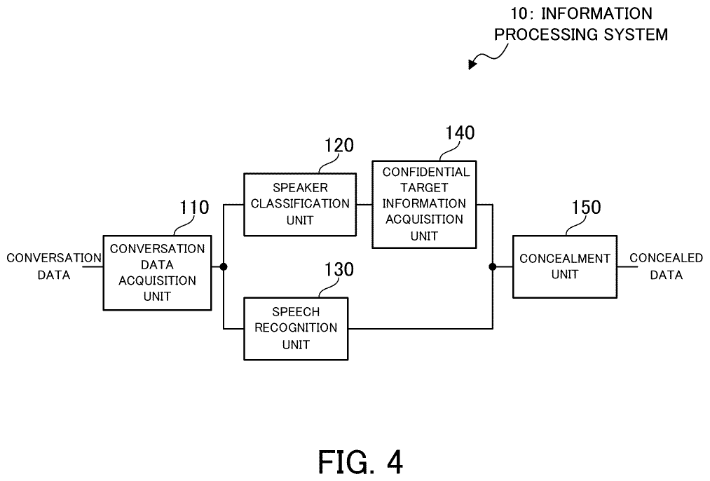

The information processing system 10 according to a second example embodiment will be described with reference to FIG. 4 to FIG. 7. The second example embodiment is partially different from the first example embodiment only in the configuration and operation, and may be the same as the first example embodiment in the other parts. For this reason, a part that is different from the first example embodiment described above will be described in detail below; and a description of other overlapping parts will be omitted as appropriate.

### (Functional Configuration)

First, a functional configuration of the information processing system 10 according to the second example embodiment will be described with reference to FIG. 4. FIG. 4 is a block diagram illustrating the functional configuration of the information processing system according to the second example embodiment. In FIG. 4, the same components as those illustrated in FIG. 2 carry the same reference numerals.

As illustrated in FIG. 4, the information processing system 10 according to the second example embodiment includes, as components for realizing the functions thereof, the conversation data acquisition unit 110, a speaker classification unit 120, the speech recognition unit 130, the confidential target information acquisition unit 140, and the concealment unit 150. That is, the information processing system 10 according to the second example embodiment further includes the speaker classification unit 120 in addition to the configuration in the first example embodiment (see FIG. 2). The speaker classifier 120 may be a processing block realized or implemented by the processor 11 (see FIG. 1), for example.

The speaker classification unit 120 is configured to perform a process of classifying the speech information in the conversation data for each speaker (hereinafter referred to as a “speaker classification process” as appropriate). The speaker classification process may be a process of adding a label corresponding to a speaker to each section of the conversation data, for example. A detailed description of a specific technology/technique of the speaker classification process will be omitted here, because the existing technologies/techniques may be adopted to the process as appropriate.

### (Concealment Operation)

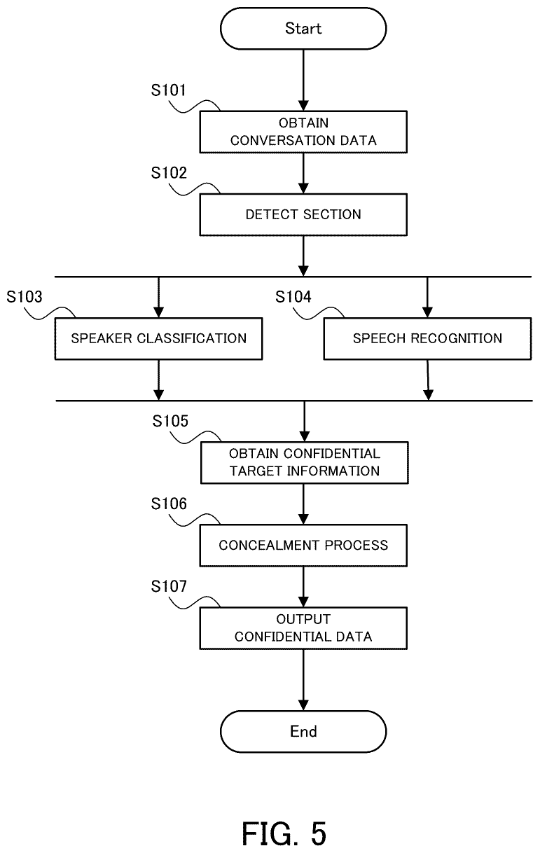

Next, a flow of an operation when a part of the conversation data is concealed (hereinafter referred to as a “concealment operation” as appropriate) by the information processing system 10 according to the second example embodiment will be described with reference to FIG. 5. FIG. 5 is a flowchart illustrating the flow of the concealment operation by the information processing system according to the second example embodiment. In FIG. 5, the same steps as those illustrated in FIG. 3 carry the same reference numerals.

As illustrated in FIG. 5, in the concealment operation by the information processing system 10 according to the second example embodiment, first, the conversation data acquisition unit 110 obtains the conversation data including the speech information on a plurality of people (step S101). Then, the conversation data acquisition unit 110 performs the section detection process of detecting the speaker speaking section of the conversation data (step S102).

Subsequently, the speaker classification unit 120 performs the speaker classification process on the conversation data on which the section detection process is performed (i.e., the speech information in the speaking section) (step S103). Meanwhile, the speech recognition unit 130 performs the speech recognition process on the conversation data on which the section detection process is performed (step S104). The speech recognition process and the speaker classification process may be performed simultaneously in parallel, or may be performed sequentially one after the other.

Subsequently, the confidential target information acquisition unit 140 obtains the confidential target information (step S105). Then, on the basis of the confidential target information obtained by the confidential target information acquisition unit 140, the concealment unit 150 conceals a part of the textualized conversation data (step S106). After that, the concealment unit 150 outputs the confidential data (step S107).

### (Specific Operation Example)

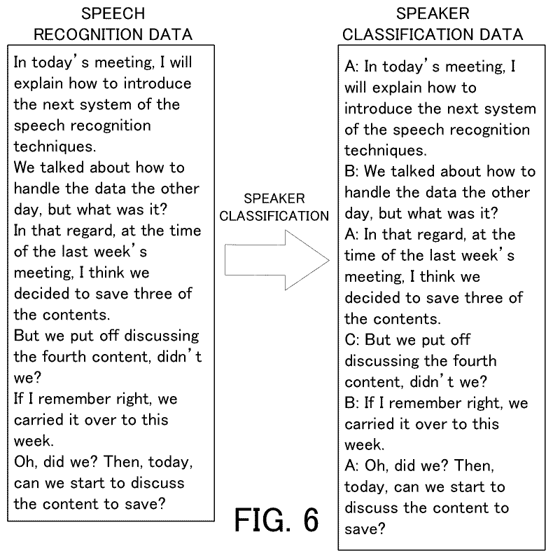

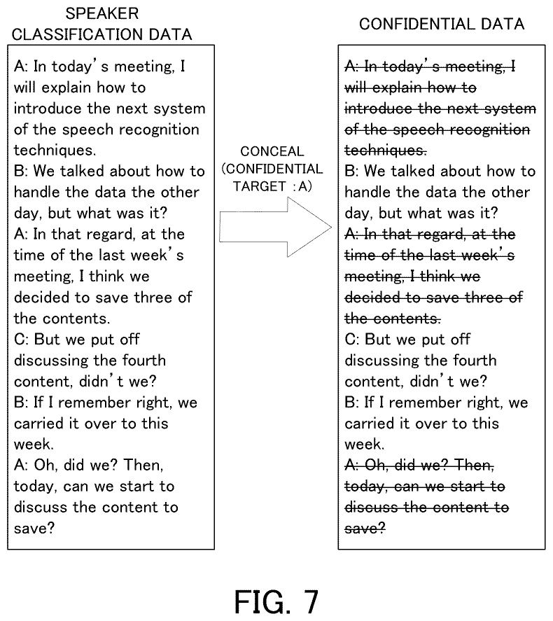

Next, the concealment operation by the information processing system 10 according to the second example embodiment will be described with reference to FIG. 6 and FIG. 7 with specific examples. FIG. 6 is a conceptual diagram illustrating a specific example of the speaker classification by the information processing system according to the second example embodiment. FIG. 7 is a conceptual diagram illustrating a specific example of concealment by the information processing system according to the second example embodiment.

Let us assume that speech recognition data (i.e., data obtained by converting the conversation data into text) as illustrated in FIG. 6 are obtained as a result of the speech recognition process performed by the speech recognition unit 130. In this case, the speaker classification unit 120 may perform the speaker classification by adding the label corresponding to the speaker to each section of the speech recognition data. In the example illustrated in FIG. 6, labels corresponding to a speaker A, a speaker B, and a speaker C are added to respective sections of the speech recognition data. This makes it possible to recognize which speaker speaks in which section.

Let us assume that speaker classification data (i.e., data obtained by the speaker classification) as illustrated in FIG. 7 are obtained as a result of the speaker classification process performed by the speaker classification unit 120. In addition, let us assume that the confidential target is identified as the speaker A from the confidential target information. In this instance, the concealment unit 150 performs the concealment process on the content of speaking/utterance of the speaker A in the speaker classification data. That is, the concealment unit 150 changes the content of speaking/utterance of the speaker A to be not browsable. Although only one speaker is set as the confidential target, a plurality of speakers may be set as the confidential target. For example, the speaker B may be set as the confidential target in addition to the speaker A. In this case, the concealment unit 150 may change the content of speaking/utterance of the speaker A and the speaker B to be not browsable.

Furthermore, in the example illustrated in FIG. 7, for convenience of description, a strikethrough is drawn on a part to be concealed, but the part to be concealed may be completely colored in so that no one can recognize characters (i.e., may black out the part). Alternatively; the part to be concealed may not be displayed. In this case, the non-display part may be left blank, or a process of filling the blank may be performed.

Furthermore, in the example illustrated in FIG. 7, all the content of speaking/utterance of the speaker who is the confidential target is concealed, but only a part of the content of speaking/utterance of the speaker who is the confidential target may be concealed. For example, when the speaker A is the confidential target, a part of the content of speaking/utterance of the speaker A may be concealed, and the remaining part may not be concealed (i.e., there may be a part that is still browsable even though it is the content of speaking/utterance of the speaker A). When partial concealment is performed in the above manner, the confidential target information may include information for identifying the part to be concealed, in addition to information for identifying the speaker who is the confidential target. A detailed description of a specific example of the partial concealment will be described in detail in another example embodiment later.

### (Technical Effect)

Next, a technical effect obtained by the information processing system 10 according to the second example embodiment will be described.

As described in FIG. 4 to FIG. 7, in the information processing system 10 according to the second example embodiment, a part of the textualized conversation data is concealed for each speaker. In this way, it is possible to properly conceal a part of the information included in the conversation data. Therefore, while a part of the conversation data (i.e., a part that is spoken by the speaker who is not the confidential target) is disclosed, the other part (i.e., a part that is spoken by the speaker who is the confidential target) can be concealed. As a result, it is possible to properly prevent information leakage from the conversation data.

In the following example embodiments, a description will be given on the premise of the configuration including the speaker classification unit 120, which is described in the second example embodiment; however, as described in the first example embodiment, the speaker classification unit 120 is not an essential component. That is, even when the speaker classification unit 120 is not provided, the technical effect in each of the example embodiments is exhibited.

### Third Example Embodiment

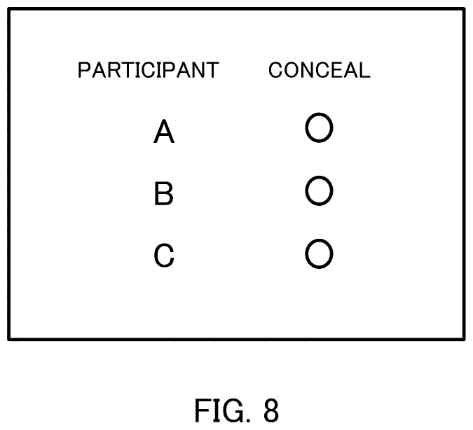

The information processing system 10 according to a third example embodiment will be described with reference to FIG. 8 to FIG. 10. The third example embodiment specifically describes display examples when the confidential target is set, and may be the same as the first and second example embodiments in the configuration and operation of the system. For this reason, a part that is different from each of the first and second example embodiments described above will be described in detail below, and a description of other overlapping parts will be omitted as appropriate.

### First Display Example

First, a first display example will be described with reference to FIG. 8. FIG. 8 is a plan view illustrating the first display example when the confidential target is set by the information processing system according to the third example embodiment.

As illustrated in FIG. 8, in the first display example, a radio button corresponding to each speaker (participant) is displayed. In this case, the confidential target can be set by selecting the radio button of the speaker who is the confidential target. For example, when the radio button of the speaker A is selected (turned on), the speaker A is set to be the confidential target. Furthermore, a plurality of confidential targets may be set by selecting a plurality of radio buttons. For example, when the radio buttons of the speaker A and the speaker B are selected (turned on), the speaker A and the speaker B may be set to be the confidential targets.

Although described here is an example of selecting the confidential target by using the radio button, a display aspect for selecting the confidential target is not limited to the radio button. For example, display may be performed to select concealment/non-concealment from a pull-down menu for each speaker.

### Second Display Example

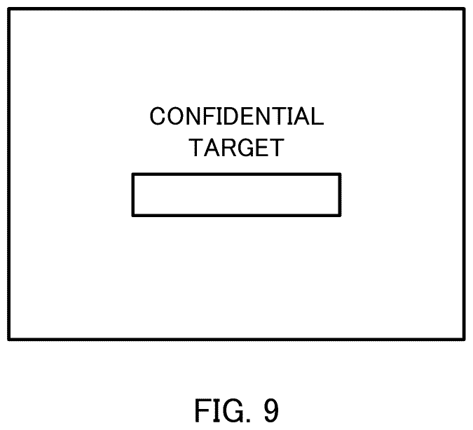

Next, a second display example will be described with reference to FIG. 9. FIG. 9 is a plan view illustrating the second display example when the confidential target is set by the information processing system according to the third example embodiment.

As illustrated in FIG. 9, in the second display example, a box is displayed to enter a word that is the confidential target. In this case, it is possible to set the confidential target by entering the word in the box. For example, when a word “meeting” is entered in the box, the word “meeting” included in the conversation data is concealed.

### Third Display Example

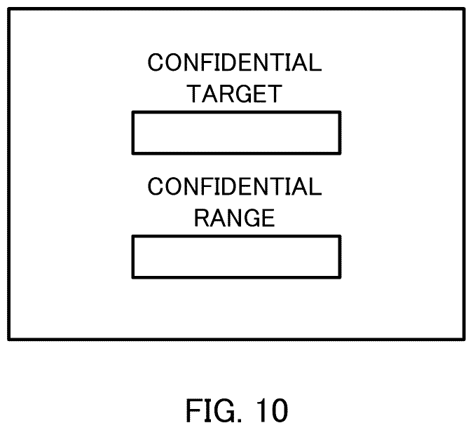

Next, a third display example will be described with reference to FIG. 10. FIG. 10 is a plan view illustrating the third display example when the confidential target is set by the information processing system according to the third example embodiment.

As illustrated in FIG. 10, in the third display example, in addition to the box for entering the word that is the confidential target described in the second display example, a box for entering a confidential range (e.g., whether only a word is concealed, or a clause, a sentence, and a paragraph including the word are concealed) is displayed. In this case, it is possible to set the confidential target by entering a word in the upper box, and it is possible to set the confidential range by entering a range to be concealed in the lower box. For example, when the word “meeting” is entered in the upper box, and “sentence” is entered in the lower box, a sentence including “meeting” in the conversation data is set to be the confidential target. The confidential range will be described in detail in another example embodiment later.

The first display example may be combined with the second display example or the third display example. For example, a part corresponding to the first display example and a part corresponding to the second display example (or the third display example) may be displayed on the same screen. In this case, the speaker who is the confidential target may be selected in the part corresponding to the first display example, and the word that is the confidential target or the confidential range may be set in the part corresponding to the second display example or the third display example.

### (Technical Effect)

Next, a technical effect obtained by the information processing system 10 according to the third example embodiment will be described.

As described in FIG. 8 to FIG. 10, in the information processing system 10 according to the third example embodiment, the display for setting the confidential target is outputted to the user. In this way, the user may be able to easily set the confidential target.

### Fourth Example Embodiment

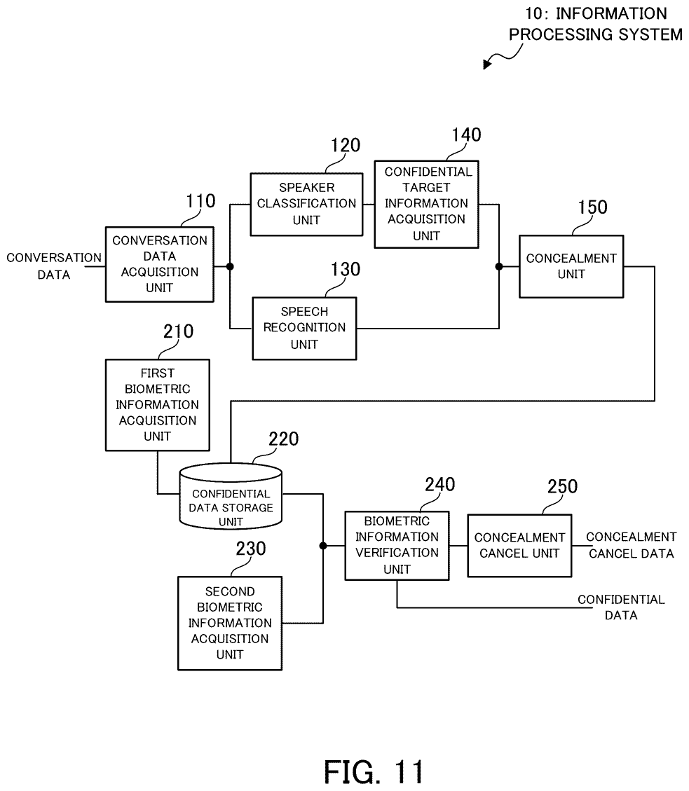

The information processing system 10 according to a fourth example embodiment will be described with reference to FIG. 11 to FIG. 13. The fourth example embodiment is partially different from the first to third example embodiments only in the configuration and operation, and may be the same as the first example embodiment in the other parts. For this reason, a part that is different from the first example embodiment described above will be described in detail below; and a description of other overlapping parts will be omitted as appropriate.

### (Functional Configuration)

First, a functional configuration of the information processing system 10 according to the fourth example embodiment will be described with reference to FIG. 11. FIG. 11 is a block diagram illustrating the functional configuration of the information processing system according to the fourth example embodiment. In FIG. 11, the same components as those illustrated in FIG. 4 carry the same reference numerals.

As illustrated in FIG. 11, the information processing system 10 according to the fourth example embodiment includes, as components for realizing the functions thereof, the conversation data acquisition unit 110, the speaker classification unit 120, the speech recognition unit 130, the confidential target information acquisition unit 140, the concealment unit 150, a first biometric information acquisition unit 210, a confidential data storage unit 220, a second biometric information acquisition unit 230, a biometric information verification unit 240, and a concealment cancel unit 250. That is, the information processing system 10 according to the fourth example embodiment further includes the first biometric information acquisition unit 210, the confidential data storage unit 220, the second biometric information acquisition unit 230, the biometric information verification unit 240, and the concealment cancel unit 250, in addition to the configuration in the second example embodiment (see FIG. 4). Each of the first biometric information acquisition unit 210, the second biometric information acquisition unit 230, the biometric information verification unit 240, and the concealment cancel unit 250 may be a processing block realized or implemented by the processor 11 (see FIG. 1), for example. The confidential data storage unit 220 may be realized or implemented by the storage apparatus 14 (see FIG. 1), for example.

The first biometric information acquisition unit 210 is configured to obtain biometric information about a speaker who participates in a conversation (hereinafter referred to as “first biometric information” as appropriate). The first biometric information is information from which the speaker can be identified. The type of the first biometric information is not particularly limited. The first biometric information may include a plurality of types of biometric information.

The first biometric information may be a feature quantity related to a voice of the speaker, for example. In this instance, the first biometric information may be obtained from the conversation data. More specifically, the first biometric information acquisition unit 210 may perform a voice analysis process on the speech information included in the conversation data, thereby to obtain the feature quantity related to the voice of the speaker, for example. Furthermore, the first biometric information may be a feature quantity related to a face of the speaker, or a feature quantity related to an iris. In this instance, the first biometric information may be obtained from an image of the speaker captured in a meeting/conference. More specifically, the first biometric information acquisition unit 210 may obtain the image of the speaker in the meeting/conference, for example, from a camera installed in a room where a conversation is carried out, a camera installed in a terminal used by each speaker, or the like, and may perform an image analysis process on the image, thereby to obtain the feature quantity related to the face or the iris. Furthermore, the first biometric information may be a feature quantity related to a fingerprint of the speaker. In this instance, the first biometric information may be obtained from a fingerprint authentication terminal installed in the room where the conversation is carried out. Although described here is an example of obtaining the first biometric information in the conversation, the first biometric information may be obtained at another timing. For example, the first biometric information may be biometric information about each speaker registered in advance before the start of the conversation. Alternatively, the first biometric information may be biometric information about each speaker separately obtained after the end of the conversation.

The confidential data storage unit 220 is configured to store the confidential data (i.e., the text data in which a part of the conversation data is concealed) and the first biometric information obtained by the first biometric information acquisition unit 210, in association with each other. For example, the confidential data storage unit 220 may associate and store the confidential data in the conversation data by the speaker A, the speaker B, and the speaker C, with the first biometric information about the speaker A, the first biometric information about the speaker B, and the first biometric information about the speaker C. The confidential data storage unit 220 may not associate and store the confidential data, with the first biometric information about all the speakers who participate in the conversation. That is, the confidential data storage unit 220 may associate and store the confidential data, only with the first biometric information about a part of the speakers who participate in the conversation. For example, the confidential data storage unit 220 may associate and store the confidential data in the conversation data by the speaker A, the speaker B, and the speaker C, only with the first biometric information about the speaker A and the first biometric information about the speaker B, but not with the first biometric information about the speaker C.

The confidential data storage unit 220 is not an essential component to this example embodiment. When the confidential data storage unit 220 is not provided, the confidential data may be treated as one data file to which the first biometric information is added. Specifically, a data file in which the concealed conversation data are associated with the first biometric information may be generated.

The second biometric information acquisition unit 230 is configured to obtain biometric information about a user who uses the conversation data (hereinafter, referred to as “second biometric information” as appropriate). The second biometric information is, as in the first biometric information, information from which the speaker can be identified. Furthermore, the second biometric information is biometric information of the same type as that of the first biometric information stored in the confidential data storage unit 220. For example, when the first biometric information is stored as the feature quantity related to the voice, the second biometric information is the feature quantity related to the voice. When the first biometric information includes a plurality of types of biometric information, the second biometric information may be obtained as information including at least one piece of biometric information from among them. The second biometric information may be obtained by using a terminal used by the user, an apparatus installed in a room where the user is, or the like. For example, when the feature quantity related to the voice is obtained as the second biometric information, the second biometric information acquisition unit 230 may obtain a voice of the user from a microphone provided in the terminal owned by the user, and may obtain the second biometric information from the voice. In this instance, the second biometric information acquisition unit 230 may perform display encouraging the user to speak.

The biometric information verification unit 240 is configured to collage/verify the first biometric information stored in association with the conversation data (the confidential data) used by the user, with the second biometric information obtained from the user. In other words, the biometric information verification unit 240 is configured to determine whether the speaker in the conversation data and the user who uses the conversation data are the same person. Although a collation/verification method here is not particularly limited, but the biometric information verification unit 240 may calculate a degree of matching between the first biometric information and the second biometric information, thereby to perform the collation/verification, for example. More specifically, the biometric information verification unit 240 may determine that the speaker in the conversation data and the user who uses the conversation data are the same person when the degree of matching between the first biometric information and the second biometric information exceeds a predetermined threshold, and may determine that the speaker in the conversation data and the user who uses the conversation data are not the same person when the degree of matching does not exceed the predetermined threshold. The biometric information verification unit 240 may output an instruction to the second biometric information acquisition unit 230 so as to reobtain the second biometric information when the collation/verification is failed (i.e., when it does not determine that they are the same person). Then, the same collation/verification may be performed again by using the reobtained second biometric information.

The concealment cancel unit 250 is configured to cancel, release, or remove the concealment of the confidential data on the basis of a collation/verification result of the biometric information verification unit 240. For example, the concealment cancel unit 250 may cancel the concealment of the confidential data, when it can be determined that the speaker in the conversation data and the user who uses the conversation data are the same person by collating/verifying the first biometric information with the second biometric information. The concealment cancel unit 250 may cancel the concealment of all the confidential data, or may cancel the concealment of a part of the confidential data. For example, when the content of speaking/utterance of the speaker A and the speaker B in the conversation data is concealed, the concealment cancel unit 250 may cancel the concealment for both the speaker A and the speaker B, or may cancel the concealment only for one of the speaker A and the speaker B. The partial cancel of the concealment will be specifically described in another example embodiment later. The concealment cancel unit 250 may have a function of outputting data in which the concealment is canceled (hereinafter referred to as “concealment cancel data” as appropriate). For example, the concealment cancel unit 250 may display the concealed release data on a display or the like.

### (Concealment Operation)

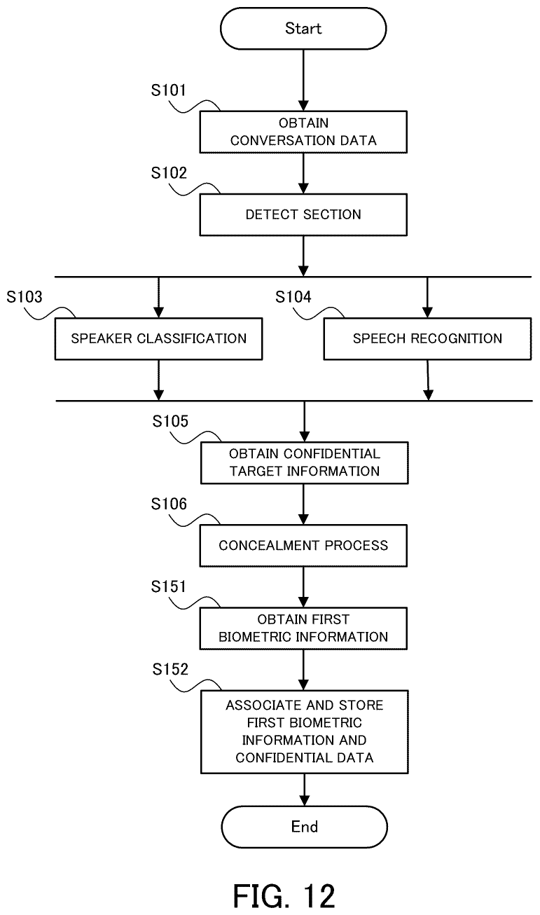

Next, a flow of the concealment operation by the information processing system 10 according to the fourth example embodiment will be described with reference to FIG. 12. FIG. 12 is a flowchart illustrating the flow of the concealment operation by the information processing system according to the fourth example embodiment. In FIG. 12, the same steps as those described in FIG. 5 carry the same reference numerals.

As illustrated in FIG. 12, in the concealment operation by the information processing system 10 according to the fourth example embodiment, first, the conversation data acquisition unit 110 obtains the conversation data including the speech information on a plurality of people (step S101). Then, the conversation data acquisition unit 110 performs the section detection process on the conversation data (step S102).

Subsequently, the speaker classification unit 120 performs the speaker classification process on the conversation data on which the section detection process is performed (step S103). Meanwhile, the speech recognition unit 130 performs the speech recognition process on the conversation data on which the section detection process is performed (step S104). The speech recognition process and the speaker classification process may be performed simultaneously in parallel, or may be performed sequentially one after the other.

Subsequently, the confidential target information acquisition unit 140 obtains the confidential target information (step S105). Then, on the basis of the confidential target information obtained by the confidential target information acquisition unit 140, the concealment unit 150 conceals a part of the textualized conversation data (step S106). Especially in the fourth example embodiment, the concealment unit 150 outputs the confidential data to the confidential data storage unit 220.

Subsequently, the first biometric information acquisition unit 210 obtains the first biometric information about the speaker who participates in the conversation (step S151). The first biometric information may be obtained simultaneously in parallel with the steps S101 to S106, or may be obtained sequentially one after the other. Thereafter, the confidential data storage unit 220 stores the confidential data outputted from the concealment unit 150 and the first biometric information obtained by the first biometric information acquisition unit 210, in association with each other (step S152).

### (Concealment Cancel Operation)

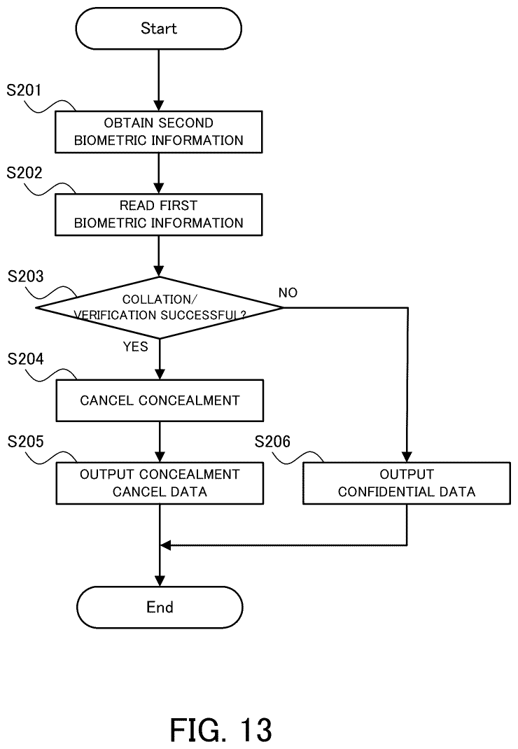

Next, with reference to FIG. 13, a flow of an operation of releasing the concealment of the conversation data (hereinafter referred to as a “concealment cancel operation” as appropriate) by the information processing system 10 according to the fourth example embodiment will be described. FIG. 13 is a flowchart illustrating the flow of the concealment cancel operation by the information processing system according to the fourth example embodiment.

As illustrated in FIG. 13, in the concealment cancel operation by the information processing system 10 according to the fourth example embodiment, first, the second biometric information acquisition unit 230 obtains the second biometric information about the user who uses the conversation data (step S201). The second biometric information acquisition unit 230 may obtain the second biometric information, for example, at a timing when the user uses the conversation data (e.g., at a timing when the user performs an operation of opening a file of the conversation data). The second biometric information obtained by the second biometric information acquisition unit 230 is outputted to the biometric information verification unit 240.

Subsequently, the biometric information verification unit 240 reads the first biometric information stored in association with the conversation data (confidential data) used by the user, from the confidential data storage unit 220 (step S202). Then, the biometric information verification unit 240 collates/verifies the second biometric information obtained by the second biometric information acquisition unit 230 and the read first biometric information (step S203).

When the collation/verification by the biometric information verification unit 240 is successful (step S203: YES), the concealment cancel unit 250 cancels the concealment of the confidential data (step S204). Then, the concealment cancel unit 250 outputs the concealment cancel data (step S205). On the other hand, when the collation/verification by the biometric information verification unit 240 is not successful (step S203: NO), the concealment cancel unit 250 does not cancel the concealment of the confidential data (i.e., the step S204 is not performed). In this instance, the concealment cancel unit 250 outputs the confidential data (step S206).

### (Technical Effect)

Next, a technical effect obtained by the information processing system 10 according to the fourth example embodiment will be described.

As described in FIG. 11 to FIG. 13, in the information processing system 10 according to the fourth example embodiment, the concealment is canceled on the basis of the collation/verification result between the first biometric information about the speaker who participates in the conversation and the second biometric information about the user who uses the conversation data. In this way, while the data obtained by canceling the concealment can be outputted to the speaker who participates in the conversation, the confidential data can be outputted to a person other than the speaker who participates in the conversation. Therefore, the conversation data are outputted in different aspects between the person who participates in the conversation and the person who does not participate in the conversation, and it is thus possible to properly protect the information included in the conversation data, depending on the situation.

### Fifth Example Embodiment

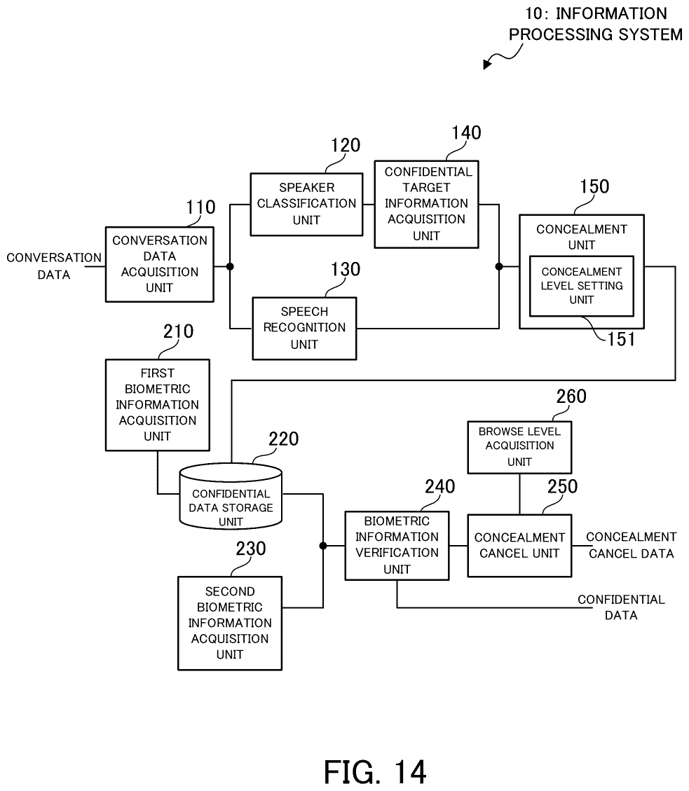

The information processing system 10 according to a fifth example embodiment will be described with reference to FIG. 14 to FIG. 17. The fifth example embodiment is partially different from the first to fourth example embodiments only in the configuration and operation, and may be the same as the first to fourth example embodiments in the other parts. For this reason, a part that is different from each of the example embodiments described above will be described in detail below; and a description of other overlapping parts will be omitted as appropriate.

### (Functional Configuration)

First, a functional configuration of the information processing system 10 according to the fifth example embodiment will be described with reference to FIG. 14. FIG. 14 is a block diagram illustrating the functional configuration of the information processing system according to the fifth example embodiment. In FIG. 14, the same components as those illustrated in FIG. 11 carry the same reference numerals.

As illustrated in FIG. 14, the information processing system 10 according to the fifth example embodiment includes, as components for realizing the functions thereof, the conversation data acquisition unit 110, the speaker classification unit 120, the speech recognition unit 130, the confidential target information acquisition unit 140, the concealment unit 150, the first biometric information acquisition unit 210, the confidential data storage unit 220, the second biometric information acquisition unit 230, the biometric information verification unit 240, the concealment cancel unit 250, and a browse level acquisition unit 260. That is, the information processing system 10 according to the fifth example embodiment further includes the browse level acquisition unit 260 in addition to the configuration in the fourth example embodiment (see FIG. 11). The browse level acquisition unit 260 may be a processing block realized or implemented by the processor 11 (see FIG. 1), for example. Furthermore, the concealment unit 150 according to the fifth example embodiment includes a concealment level setting unit 151.

The concealment level setting unit 151 is configured to set a concealment level for a spot concealed in the confidential data. The concealment level may be set as one level that is common to all the confidential data, or may be set separately for each concealed spot. Here, the “concealment level” is a level that is set in accordance with how severely to conceal a spot to be concealed.

For example, the concealment level setting unit 151 may set a high concealment level for relatively highly confidential information, and may set a low concealment level for relatively less confidential information. The concealment level may be expressed by a number, for example. Specifically, the concealment level may be set to increase, such as a concealment level 1, a concealment level 2, a concealment level 3, and so on. In addition, the concealment level may be set in accordance with a target to be desirably concealed (i.e., a target to whom information to be concealed is not desirably known). For example, the concealment level setting unit 151 may set a concealment level A, for a target to be desirably concealed from a user who belongs to a department A, and may set a concealment level B for a target to be desirably concealed from a user who belongs to a department B. Furthermore, the concealment level setting unit 151 may set a concealment level C for a target to be desirably concealed from both the user who belongs to the department A and the user who belongs to the department B.

The browse level acquisition unit 260 is configured to obtain a browse level for the user who uses the conversation data. Here, the “browse level” is a level corresponding to the concealment level described above, and is a level indicating up to which concealment level the user can cancel the concealment. The user may cancel the concealment of a confidential spot of the concealment level corresponding to the browse level of the user. For example, as the browse level is higher, the concealment of a higher concealment level can be canceled.

The browse level may be set in advance for each user. The browse level may be set in accordance with an affiliated department or a position, or the like, for example. Specifically, the user who belongs to a department where confidential information needs to be known, may be set high in the browse level, and the user who belongs to a department where the confidential information does not need to be known, may be set low in the browse level. Furthermore, the user with a higher position may be set high in the browse level. For example, a department manager may be set to have a “browse level 3,” a section chief may be set to have a “browse level 2.” and others with a lower position may be set to have a “browse level 1.”

The browse level acquisition unit 260 may obtain the browse level by reading an ID card owned by the user, for example. Alternatively, the browse level acquisition unit 260 may obtain the browse level by performing a user authentication process (i.e., a process of identifying the user). In this case, the biometric information may be used for the authentication of the user, and the second biometric information obtained by the second biometric information acquisition unit 230 may be used.

### (Concealment Cancel Operation)

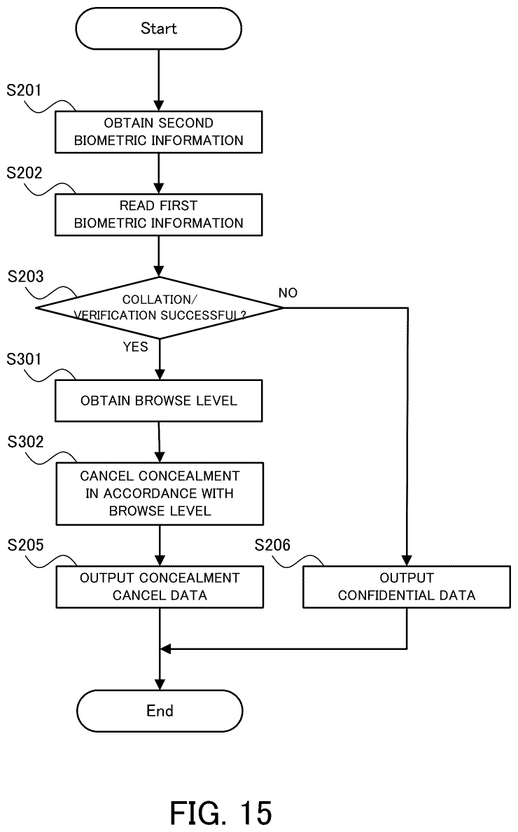

Next, a flow of the concealment cancel operation by the information processing system 10 according to the fifth example embodiment will be described with reference to FIG. 15. FIG. 15 is a flowchart illustrating the flow of the concealment cancel operation by the information processing system according to the fifth example embodiment. In FIG. 15, the same steps as those illustrated in FIG. 13 carry the same reference numerals.

As illustrated in FIG. 15, in the concealment cancel operation by the information processing system 10 according to the fifth example embodiment, first, the second biometric information acquisition unit 230 obtains the second biometric information about the user who uses the conversation data (step S201). Especially in this example embodiment, the concealment level is assumed to be set in the conversation data used by the user. That is, the concealment level setting unit 151 is assumed to set the concealment level for each concealed spot.

Subsequently, the biometric information verification unit 240 reads the first biometric information stored in association with the conversation data (confidential data) used by the user, from the confidential data storage unit 220 (step S202). Then, the biometric information verification unit 240 collates/verifies the second biometric information obtained by the second biometric information acquisition unit 230 and the read first biometric information (step S203).

When the collation/verification by the biometric information verification unit 240 is successful (step S203: YES), the browse level acquisition unit 260 obtains the browse level of the user (step S301). The step S301 may be performed simultaneously in parallel with the steps S201 to S203, or may be performed sequentially one after the other.

Subsequently, the concealment cancel unit 250 cancels the concealment of the confidential data on the basis of the concealment level and the browse level (step S302). Then, the concealment cancel unit 250 outputs the concealment cancel data (step S205).

On the other hand, when the collation/verification by the biometric information verification unit 240 is not successful (step S203: NO), the concealment cancel unit 250 does not cancel the concealment of the confidential data (i.e., the step S204 is not performed). In this instance, the concealment cancel unit 250 outputs the confidential data (step S206).

### (Level Setting Example)

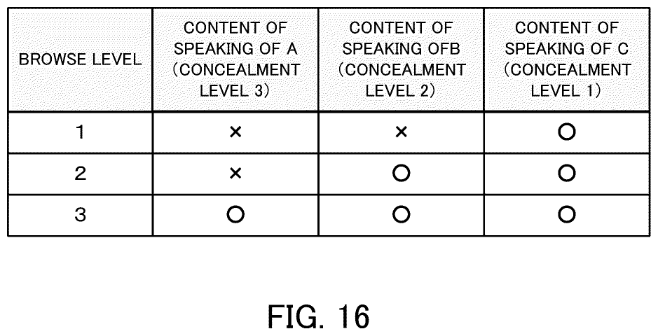

Next, a specific example of setting the concealment level and the browse level by the information processing system 10 according to the fifth example embodiment will be described with reference to FIG. 16. FIG. 16 is a table illustrating a correlation between the concealment level and the browse level in the information processing system according to the fifth example embodiment.

In the example illustrated in FIG. 16, three concealment levels are set (from a lower side, the concealment level 1, the concealment level 2, and the concealment level 3). Furthermore, three browse levels are set (from a lower side, the browse level 1, the browse level 2, and the browse level 3). In this case, the number of the concealment levels is the same as the number of the browse levels, but the number of the concealment levels may not necessarily match the number of the browse levels. For example, while three concealment levels are set, four browse levels may be set.

As illustrated in FIG. 16, the concealment level may be set depending on who speaks. In the example of FIG. 16, the content of speaking/utterance of the speaker A is set to the “concealment level 3,” the content of speaking/utterance of the speaker B is set to the “concealment level 2.” and the content of speaking/utterance of the speaker C is set to the “concealment level 1.” That is, the content of speaking/utterance of the speaker A is the most confidential, the c content of speaking/utterance of the speaker B is moderately confidential, and the c content of speaking/utterance of the speaker C is the least confidential. When the concealment level is set for each speaker in the above manner, the concealment level may be set in accordance with an affiliated department or a position of each speaker, or the like, for example as in the browse level. Alternatively, when the browse level is set for each speaker, the concealment level may be set in accordance with the browse level. For example, the concealment level 3 may be set for the content of speaking/utterance of a speaker of the browse level 3, the concealment level 2 may be set for the content of speaking/utterance of a speaker of the browse level 2, and the concealment level 1 may be set for the content of speaking/utterance of a speaker of the browse level 1.

In the example illustrated in FIG. 16, the concealment can be cancelled in the concealment level that is lower than the browse level of the user. For example, the user of the browse level 1 can cancel the content of speaking/utterance of the speaker C of the concealment level 1, but cannot cancel the content of speaking/utterance of the speaker B of the concealment level 2 and that of the speaker A of the concealment level 3. The user of the browse level 2 can cancel the content of speaking/utterance of the speaker C of the concealment level 1 and that of the speaker B of the concealment level 2, but cannot cancel the content of speaking/utterance of the speaker A of the concealment level 3. The user of the browse level 3 can cancel any of the content of speaking/utterance of the speaker C of the concealment level 1, that of the speaker B of the concealment level 2, and that of the speaker A of the concealment level 3.

Although it is not described here, a perfect concealment level (e.g., a concealment level 4) in which the concealment cannot be canceled regardless of the browse level may be set. For a spot where the perfect concealment level is set, basically, the concealment cannot be canceled by the user, and it may be set such that only a system manager/administrator or a user with special approval can cancel the concealment.

### <Display Example of Level Setting>

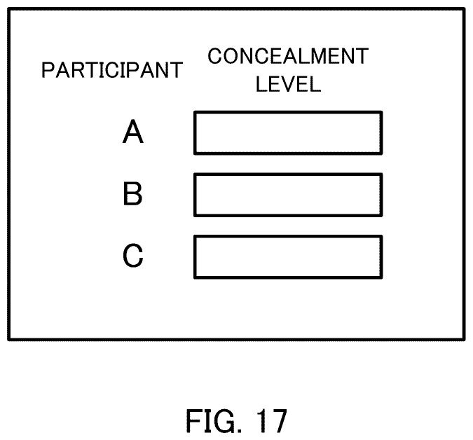

Next, a display example when the concealment level is set, will be specifically described with reference to FIG. 17. FIG. 17 is a plan view illustrating the display example when the concealment level is set by the information processing system according to the fifth example embodiment.

As illustrated in FIG. 17, in the information processing system 10 according to the fifth example embodiment, a box corresponding to each speaker (participant) is displayed. In this case, it is possible to set the concealment level for each speaker by entering the concealment level (e.g., a numerical value) in the box. The concealment level may be selectable using a radio button, a pull-down menu, or the like. In this case, the concealment level may be selectable from numerical values indicating the level (e.g., a level 1, a level 2, a level 3, etc.), or may be selectable from a target that can browse (e.g., the same section, the same department, the same position, the entire company, etc.).

In addition to or instead of the above-described selection for each speaker, the concealment level of each word that is the confidential target may be set. In this case, the concealment level for each word may be set on the same screen as the one for setting the concealment level for each speaker. Alternatively, the concealment level for each word may be set on a different screen (e.g., a screen for setting the word that is the confidential target, described in FIG. 9 and FIG. 10) from the one for setting the concealment level for each speaker. Furthermore, the concealment level of the word may be set for each speaker. For example, the word “meeting” said by the speaker A may be set to be the confidential target, and a word “save” said by the speaker A may not be set to be the confidential target. Meanwhile, the word “meeting” said by the speaker B may not be set to be the confidential target, and the word “save” said by speaker B may be set to be the confidential target.

### (Technical Effect)

Next, a technical effect obtained by the information processing system 10 according to the fifth example embodiment will be described.

As described in FIG. 14 to FIG. 17, according to the information processing system 10 in the fifth example embodiment, the concealment is canceled in accordance with the concealment level and the browse level. In this way, it is possible to properly protect the information in accordance with the confidentiality of the information concealed and the authority of the user who uses the conversation data.

### Sixth Example Embodiment

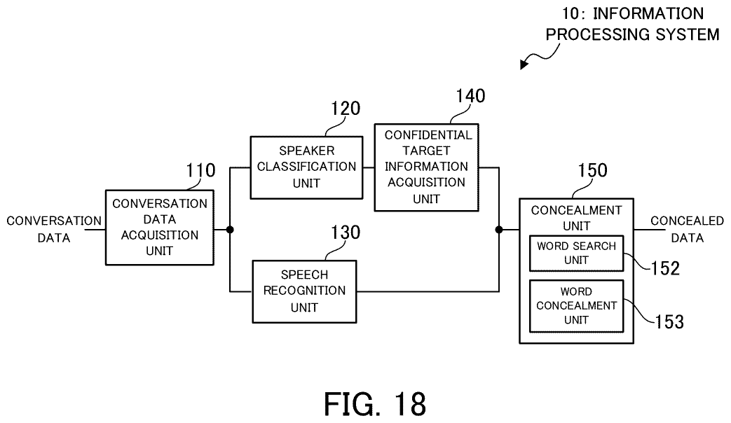

The information processing system 10 according to a sixth example embodiment will be described with reference to FIG. 18 to FIG. 20C. The sixth example embodiment is partially different from the first to fifth example embodiments only in the configuration and operation, and may be the same as the first to fifth example embodiments in the other parts. For this reason, a part that is different from each of the example embodiments described above will be described in detail below; and a description of other overlapping parts will be omitted as appropriate.

### (Functional Configuration)

First, a functional configuration of the information processing system 10 according to the sixth example embodiment will be described with reference to FIG. 18. FIG. 18 is a block diagram illustrating the functional configuration of the information processing system according to the sixth example embodiment. In FIG. 18, the same components as those illustrated in FIG. 4 carry the same reference numerals.

As illustrated in FIG. 18, the information processing system 10 according to the sixth example embodiment includes, as components for realizing the functions thereof, the conversation data acquisition unit 110, the speaker classification unit 120, the speech recognition unit 130, the confidential target information acquisition unit 140, and the concealment unit 150. The confidential target information acquisition unit 140 according to the sixth example embodiment is configured to obtain information that identifies a word to be concealed, as the confidential target information. In particular, the concealment unit 150 according to the sixth example embodiment includes a word search unit 152 and a word concealment unit 153.

The word search unit 152 is configured to search for the word identified by the confidential target information (i.e., the word to be concealed) from the textualized conversation data. When the speaker who is the confidential target is set, the word search unit 152 may search only the content of speaking/utterance of the speaker for the word. That is, the content of speaking/utterance of the speaker who is not the confidential target does not need to be searched. The word to be concealed may be specified by the speaker who participates in the conversation, for example. Specifically, when the speaker enters the word “meeting”, the “meeting” may be set as the word to be concealed. In this case, the speaker who specifies the word to be concealed may enter the word by the speech recognition, by saying the word. Furthermore, the word to be concealed may be automatically determined in accordance with a degree of importance of the word. For example, a word of high importance may be stored in a database in advance, and the word may be set as the word to be concealed.

The word concealment unit 153 is configured to conceal a part of the textualized conversation data in accordance with a search result of the word search unit 152. That is, the word concealment unit 153 is configured to conceal the word found by the search of the word search unit 152. The word concealment unit 153 may conceal only the word, or may conceal a description related to the word (e.g., a description of a periphery including the word). Specific examples of the concealment of the description related to the word will be described in detail later.

### (Concealment Operation)

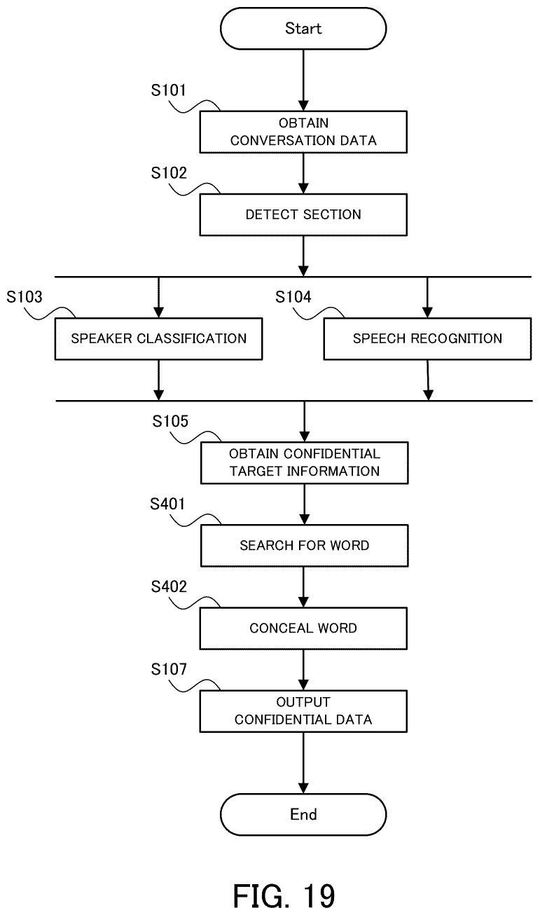

Next, a flow of the concealment operation by the information processing system 10 according to the sixth example embodiment will be described with reference to FIG. 19. FIG. 19 is a flowchart illustrating the flow of the concealment operation by the information processing system according to the sixth example embodiment.

As illustrated in FIG. 19, in the concealment operation by the information processing system 10 according to the sixth example embodiment, first, the conversation data acquisition unit 110 obtains the conversation data including the speech information on a plurality of people (step S101). Then, the conversation data acquisition unit 110 performs the section detection process (step S102).

Subsequently, the speaker classification unit 120 performs the speaker classification process on the conversation data on which the section detection process is performed (step S103). Meanwhile, the speech recognition unit 130 performs the speech recognition process on the conversation data on which the section detection process is performed (step S104). The speech recognition process and the speaker classification process may be performed simultaneously in parallel, or may be performed sequentially one after the other.

Subsequently, the confidential target information acquisition unit 140 obtains the confidential target information (step S105). The word search unit 152 then searches for the word identified by the confidential target information, from the textualized conversation data (step S401).

Subsequently, the word concealment unit 153 conceals the word on the basis of the search result by the word search unit 152 (step S402). After that, the concealment unit 150 outputs the confidential data (step S107).

### (Specific Examples of Concealment)

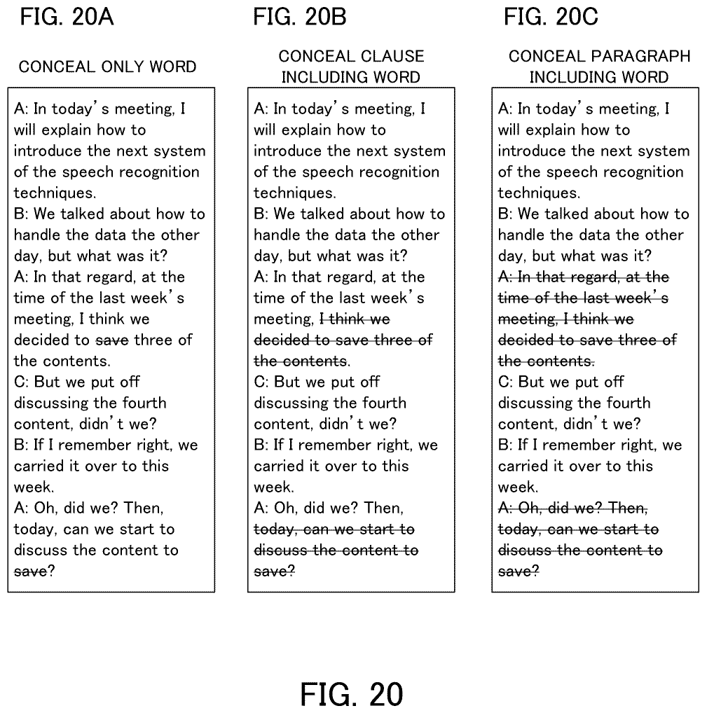

Next, specific examples of the concealment operation by the information processing system 10 according to the sixth example embodiment will be described with reference to FIG. 20A to FIG. 20C. FIG. 20A to FIG. 20C are conceptual diagrams illustrating the specific examples of the concealment by the information processing system according to the sixth example embodiment.

As illustrated in FIG. 20A, the word concealment unit 153 may conceal only the word searched by the word retrieval unit 152. Here, the word “save” is set as the word to be concealed, and thus, only the word “save” in the text data is concealed. Although only one word is concealed in this example, a plurality of words may be set as words to be concealed.

As illustrated in FIG. 20B, the word concealment unit 153 may conceal a clause including the word searched by the word retrieval unit 152. Here, the word “save” is set as the word to be concealed, and thus, a clause including “save” in the text data is concealed. A method of determining the clause including the word to be concealed is not particularly limited, but the clause may be determined in accordance with the position of punctuation marks, for example. Specifically, one clause may be determined to be from a punctuation mark immediately before the word to be concealed, to a punctuation mark immediately after the word to be concealed.

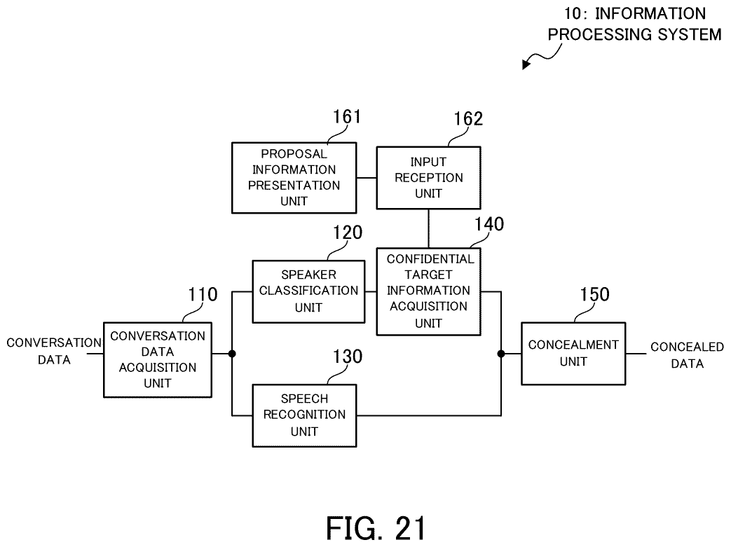

As illustrated in FIG. 21C, the word concealment unit 153 may conceal a paragraph including the word searched by the word retrieval unit 152. Here, the word “save” is set as the word to be concealed, and thus, a paragraph including “save” in the text data is concealed. A method of determining the paragraph including the word to be concealed is not particularly limited, but the paragraph may be determined ibn accordance with the start and end of speaking/utterance of one speaker, for example. Specifically, one paragraph may be determined to be a section from the start to the end of speaking/utterance of one speaker.

### (Technical Effect)

Next, a technical effect obtained by the information processing system 10 according to the sixth example embodiment will be described.

As described in FIG. 18 to FIG. 20C, in the information processing system 10 according to the sixth example embodiment, a particular word or a spot related to the word is concealed. In this way, it is possible to properly conceal the conversation data in accordance with a degree of importance of the content of speaking/utterance (specifically, whether or not the word of high importance is included). Furthermore, the number of spots to be concealed is less than in the case where all the speaking/utterance of the speaker is concealed, and it is thus possible to prevent the concealment of the content that may be disclosed.

### Seventh Example Embodiment

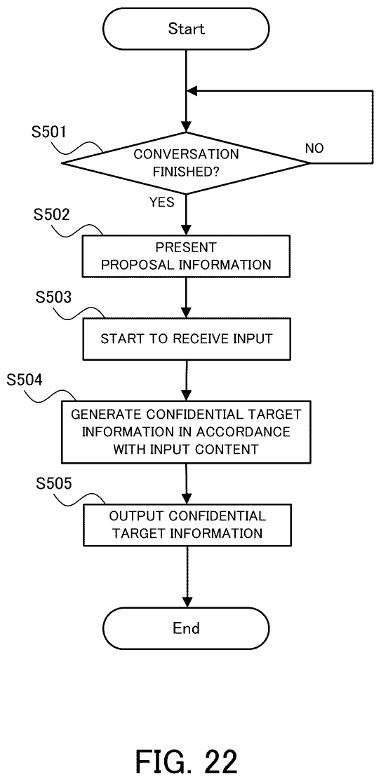

The information processing system 10 according to a seventh example embodiment will be described with reference to FIG. 21 and FIG. 22. The seventh example embodiment is partially different from the first to sixth example embodiments only in the configuration and operation, and may be the same as the first to sixth example embodiments in the other parts. For this reason, a part that is different from each of the example embodiments described above will be described in detail below; and a description of other overlapping parts will be omitted as

### (Functional Configuration)

First, a functional configuration of the information processing system 10 according to the seventh example embodiment will be described with reference to FIG. 21. FIG. 21 is a block diagram illustrating the functional configuration of the information processing system according to the seventh example embodiment. In FIG. 21, the same components as those illustrated in FIG. 4 carry the same reference numerals.

As illustrated in FIG. 21, the information processing system 10 according to the seventh example embodiment includes, as components for realizing the functions thereof, the conversation data acquisition unit 110, the speaker classification unit 120, the speech recognition unit 130, the confidential target information acquisition unit 140, the concealment unit 150, a proposal information presentation unit 161, and an input reception unit 162. That is, the information processing system 10 according to the seventh example embodiment further includes the proposal information presentation unit 161 and the input reception unit 162, in addition to the configuration in the second example embodiment (see FIG. 4). The proposal information presentation unit 161 may be realized or implemented by the output apparatus 16 (see FIG. 1), for example. The input reception unit 162 may be implemented by the input apparatus 15 (see FIG. 1), for example.

The proposal information presentation unit 161 is configured to present information (hereinafter referred to as “proposal information” as appropriate) encouraging at least one of the speakers who participate in the conversation, to enter the confidential target information, after the conversation is finished. The proposal information presentation unit 161 may display the proposal information by using a display: More specifically, the proposal information presentation unit 161 may pop up a message such as “Please enter the target to be concealed.” on the display of the terminal used by the speaker. Alternatively, the proposal information presentation unit 161 may audio-output the proposal information from a speaker device. More specifically, the proposal information presentation unit 161 may output a message such as “Please enter the target to be concealed.” from the speaker device.

The input reception unit 162 receives an input/entry of the confidential target information by the speaker who participates. That is, the input reception unit 162 receives the confidential target information entered by the speaker, as a result of the encouragement by the proposal information presented by the proposal information presentation unit 161. The input reception unit 162 may receive the confidential target information by an operation of a keyboard, a mouse, or a touch panel, for example. Alternatively, the input reception unit 162 may receive the confidential target information by the speech recognition of a voice/speech obtained by a microphone (i.e., by the speaking/utterance by the speaker). For example, when the speaker says “Mr. A, the budget,” the input reception unit may set the word “budget” in the content of speaking/utterance of the speaker A, as the target to be concealed.

### (Confidential Target Information Acquisition Operation)

Next, with reference to FIG. 22, a flow of an operation when the confidential target information is obtained (hereinafter referred to as a “confidential target information acquisition operation” as appropriate) by the information processing system 10 according to the seventh example embodiment will be described. FIG. 22 is a flow chart illustrating the flow of the confidential target information acquisition operation by the information processing system according to the seventh example embodiment.

As illustrated in FIG. 22, in the confidential target information acquisition operation by the information processing system 10 according to the seventh example embodiment, when the conversation is finished (step S501: YES), the proposal information presentation unit 161 presents the proposal information (step S502). The proposal information presentation unit 161 may present the proposal information immediately after the conversation is finished, or may present the proposal information after a lapse of a predetermined period from when the end of the conversation. The end of the conversation may be automatically determined from the voice/speech or the like, or may be determined by an operation by the speaker (e.g., an operation of a conversation end button, etc.).

Subsequently, the input reception unit 162 starts to receive the input/entry of the confidential target information by the speaker (step S503). After that, when the input/entry by the speaker is performed, the input reception unit 162 generates the confidential target information in accordance with input content (step S504). The input reception unit 162 outputs the generated confidential target information to the confidential target information acquisition unit 140 (step S505).

### (Technical Effect)

Next, a technical effect obtained by the information processing system 10 according to the seventh example embodiment will be described.

As described in FIG. 21 and FIG. 22, in the information processing system 10 according to the seventh example embodiment, the proposal information is presented after the conversation is finished, and the confidential target information is then obtained in accordance with the input content entered/inputted by the speaker. In this way, it is possible to reliably conceal the content of speaking/utterance that is determined by the speaker to be concealed. Especially in this example embodiment, since the confidential target is determined when the conversation is finished, the speaker can determine confidential target, more easily than when the confidential target is determined before or during the conversation. For example, after the conversation is finished, the speaker can see a whole image of the conversation and properly determine which content of speaking/utterance should be concealed.

### Eighth Example Embodiment

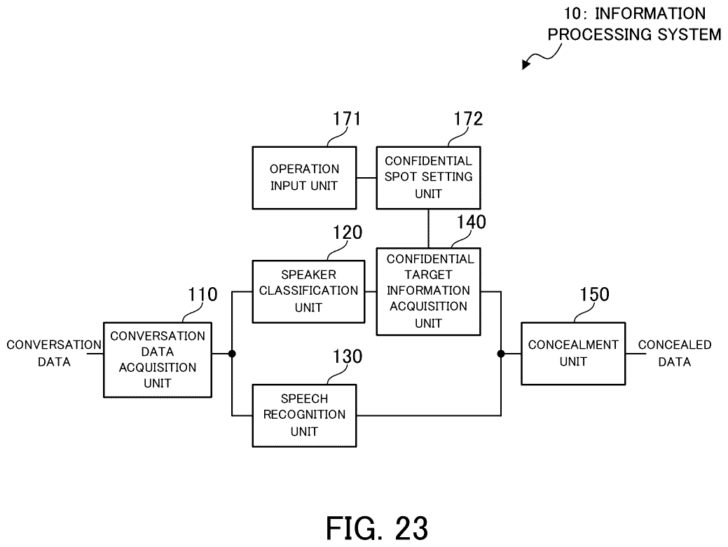

The information processing system 10 according to an eighth example embodiment will be described with reference to FIG. 23 to FIG. 25. The eighth example embodiment is partially different from the first to seventh example embodiments only in the configuration and operation, may be the same as the first to seventh example embodiments in the other parts. For this reason, a part that is different from each of the example embodiments described above will be described in detail below; and a description of other overlapping parts will be omitted as appropriate.

### (Functional Configuration)

First, a functional configuration of the information processing system 10 according to the eighth example embodiment will be described with reference to FIG. 23. FIG. 23 is a block diagram illustrating the functional configuration of the information processing system according to the eighth example embodiment. In FIG. 23, the same components as those illustrated in FIG. 7 carry the same reference numerals.

As illustrated in FIG. 23, the information processing system 10 according to the eighth example embodiment includes, as components for realizing the functions thereof, the conversation data acquisition unit 110, the speaker classification unit 120, the speech recognition unit 130, the confidential target information acquisition unit 140, the concealment unit 150, an operation input unit 171, and a confidential spot setting unit 172. That is, the information processing system 10 according to the eighth example embodiment further includes the operation input unit 171 and the confidential spot setting unit 172 in addition to the configuration in the first example embodiment (see FIG. 7). The operation input unit 171 may be realized or implemented by the input apparatus 15 (see FIG. 1), for example. The confidential spot setting unit 172 may be realized or implemented by the processor 11 (see FIG. 1), for example.

The operation input unit 171 is configured to receive an operation by the speaker who participates in the conversation. More specifically, the operation input unit 171 is configured to receive an operation for setting a confidential spot by the speaker. The operation input unit 171 may receive an input/entry from the speaker, by an operation of a keyboard, a mouse, a touch panel, or the like, for example. Alternatively, the input reception unit 162 may receive the input/entry from the speaker by the speech recognition using a microphone. The operation input unit 171 may have a function of displaying the textualized conversation data so as to assist the input/entry from the speaker.

The confidential spot setting unit 172 is configured to set the confidential spot in the conversation data in accordance with operation content received by the operation input unit 171. The confidential spot setting unit 172 is configured to generate the confidential target information for identifying the confidential spot and to output it to the confidential target information acquisition unit 140.

### (Confidential Target Information Acquisition Operation)

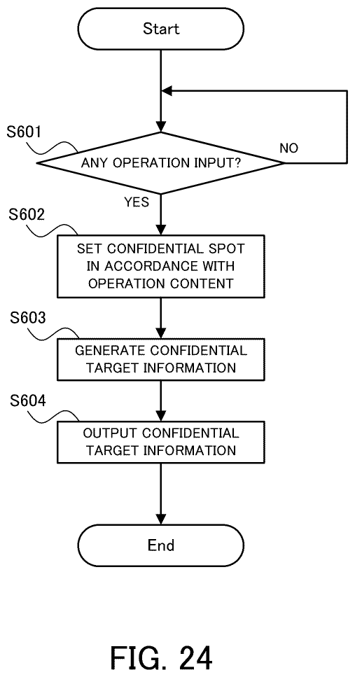

Next, with reference to FIG. 24, a flow of the confidential target information acquisition operation by the information processing system 10 according to the eighth example embodiment will be described. FIG. 24 is a flow chart illustrating the flow of the confidential target information acquisition operation by the information processing system according to the eighth example embodiment.

As illustrated in FIG. 24, in the confidential target information acquisition operation by the information processing system 10 according to the eighth example embodiment, when there is an operation input from the speaker through the operation input unit 171 (step S601: YES), the confidential spot setting unit 172 sets a spot to be concealed in accordance with the operation content (step S602).

Subsequently, the confidential spot setting unit 172 generates the confidential target information for identifying the spot to be concealed (step S603). The confidential spot setting unit 172 outputs the generated confidential target information to the confidential target information acquisition unit 140 (step S604).

### (Display Example of Operation Terminal)

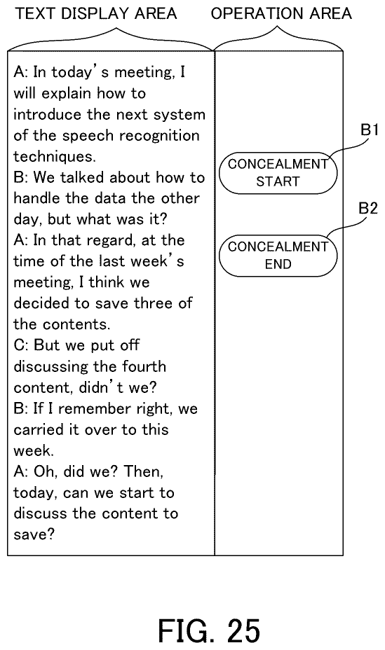

Next, a display example of an operation terminal (i.e., the operation input unit 171) operated by the speaker will be specifically described with reference to FIG. 25. FIG. 25 is a plan view illustrating the display example of the operation terminal by the information processing system according to the eighth example embodiment.

In the example illustrated in FIG. 25, the operation terminal is configured as a terminal having a display of a touch panel. The display of the operation terminal may be set to include a text display area and an operation area. The text display area displays the textualized conversation data. The textualized conversation data may be sequentially displayed to follow the conversation. On the other hand, the operation area may display a button for receiving an operation by the speaker. The text display area and the operation area may be displayed in different windows. The text display area and the operation area may be displayed on different screens.

In the example illustrated in FIG. 25, a concealment start button B1 and a concealment end button B2 are displayed in the operation area. In this case, when the speaker presses the concealment start button B1, the content of subsequent speaking/utterance is sequentially set as the spot to be concealed. Then, when the speaker presses the concealment end button B2, the content of speaking/utterance up to that point is determined to be the spot to be concealed. Although the two buttons of the concealment start button B1 and the concealment end button B2 are illustrated here, they may be displayed as a single common button. In that case, when the button is firstly pressed, the content of subsequent speaking/utterance is sequentially set as the spot to be concealed, and when the button is pressed again, the content of speaking/utterance up to that point is determined to be the spot to be concealed. Alternatively, the content of speaking/utterance during a long press of the button may be set as the spot to be concealed.

The setting of the confidential spot by the speaker may be performed on only the content of speaking/utterance of the speaker, or may be performed on that of all the speakers who participate in the conversation. In addition, each speaker may be allowed to set the confidential spot for some speaker. For example, the speaker A may be allowed to set the confidential spot for the speaker B and the speaker C, the speaker B may be allowed to set the confidential spot for the speaker C, and the speaker C may be allowed to set the confidential spot for nobody.

As described above, when the confidential spot is manually set, a keyword included in the spot may be extracted, and a frequently appearing keyword that is extracted more than a predetermined number of times may be automatically set as the confidential spot without any operation by the speaker. In addition, the frequently appearing keyword may be presented to the speaker as a candidate of the confidential spot, thereby to allow the speaker to select whether or not to set it as the confidential spot.

### (Technical Effect)

Next, a technical effect obtained by the information processing system 10 according to the eighth example embodiment will be described.

As described in FIG. 22 to FIG. 25, in the information processing system 10 according to the eighth example embodiment, the confidential spot is set in accordance with the operation by the speaker. In this way, the speaker may be able to freely set a part to be concealed, and it is possible to protect the information, more properly.

### Ninth Example Embodiment

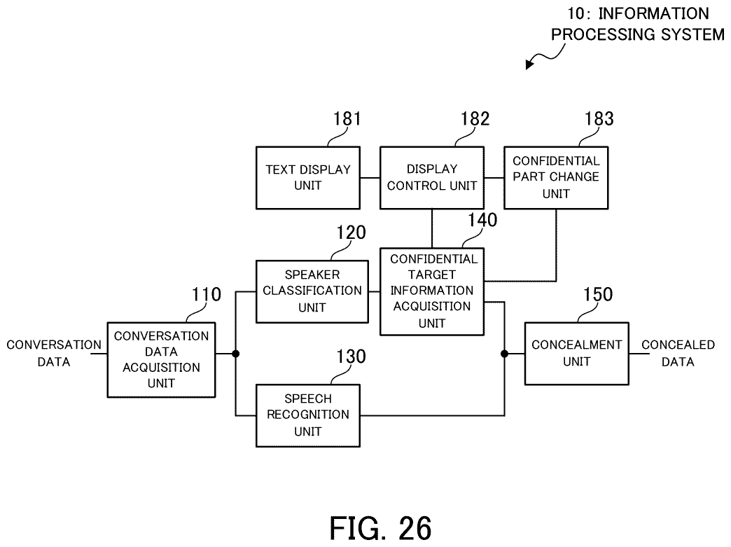

The information processing system 10 according to a ninth example embodiment will be described with reference to FIG. 26 to FIG. 29. The ninth example embodiment is partially different from the first to eighth example embodiments only in the configuration and operation, and may be the same as the first to eighth example embodiments in the other parts. For this reason, a part that is different from each of the example embodiments described above will be described in detail below; and a description of other overlapping parts will be omitted as appropriate.

### (Functional Configuration)

First, a functional configuration of the information processing system 10 according to the ninth example embodiment will be described with reference to FIG. 26. FIG. 26 is a block diagram illustrating the functional configuration of the information processing system according to the ninth example embodiment. In FIG. 26, the same components as those illustrated in FIG. 4 carry the same reference numerals.

As illustrated in FIG. 26, the information processing system 10 according to the ninth example embodiment includes, as components for realizing the functions thereof, the conversation data acquisition unit 110, the speaker classification unit 120, the speech recognition unit 130, the confidential target information acquisition unit 140, the concealment unit 150, a text display unit 181, a display control unit 182, and a confidential part change unit 183. That is, the information processing system 10 according to the ninth example embodiment further includes the text display unit 181, the display control unit 182, and the confidential part change unit 183, in addition to the configuration in the second example embodiment (see FIG. 4). The text display unit 181 may be realized or implemented by the output apparatus 16 (see FIG. 1), for example. Each of the display control unit 182 and the confidential part change unit 183 may be realized or implemented by the processor 11 (see FIG. 1), for example.

The text display unit 181 is configured to display the textualized conversation data. The text display 181 may be configured to display text to follow the conversation. The text display unit 181 may also be configured to display text corresponding to a past conversation back in a period of time. The display of the text display unit 181 is configured to be controlled by the display control unit 182 described below.

The display control unit 182 is configured to control a display unit to display a part to be concealed (hereinafter referred to as a “confidential part” as appropriate) and a part not to be concealed (hereinafter referred to as a “non-confidential part” as appropriate) in the textualized conversation data, in different aspects. Display aspects of the confidential part and the non-confidential part are not particularly limited, but the display control unit 182 may display the confidential part and the non-confidential part in different colors, for example.

The confidential part change unit 183 is configured to detect an operation using the input apparatus 15, for example. The confidential part change unit 183 is configured to change the confidential part to the non-confidential part in accordance with the content of the operation by the speaker who participates in the conversation. That is, the confidential part change unit 183 may change the part that would have been concealed if unchanged, to the part not to be concealed. The confidential part change unit 183 may detect, as a change operation, an operation in which the confidential part and the non-confidential part are touched, an operation in which the concealed/non-confidential parts are dragged, or the like, for example. In addition, the confidential part change unit 183 may be configured to change the non-confidential part to the confidential part. The change by the confidential part change unit 183 is reflected in the confidential target information, by which the change is also reflected in the process of concealment by the concealment unit 150. The change by the confidential part change unit 183 is also outputted to the display control unit 182, and the display aspect by the text display unit 181 is also changed.

### (Confidential Part Change Operation)

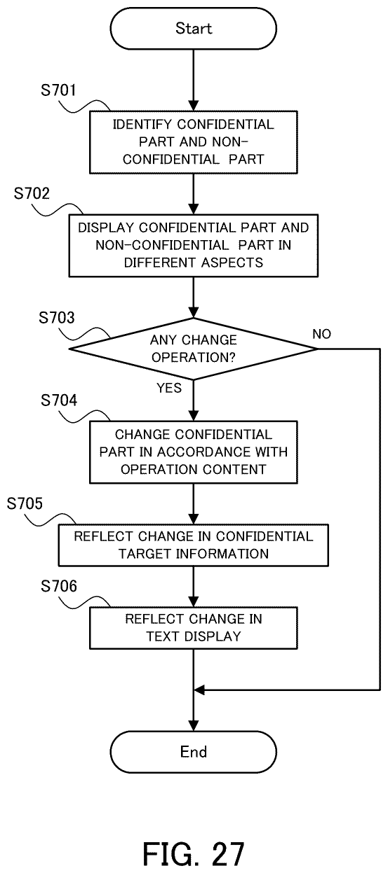

Next, a flow of an operation of changing the part to be concealed (hereinafter referred to as a “confidential part change operation” as appropriate) by the information processing system 10 according to the ninth example embodiment will be described with reference to FIG. 27. FIG. 27 is a flowchart illustrating the flow of the confidential part change operation by the information processing system according to the ninth example embodiment.

As illustrated in FIG. 27, in the confidential part change operation by the information processing system 10 according to the ninth example embodiment, first, the display control unit 182 identifies the confidential part and the non-confidential part on the basis of the confidential target information (step S701). Then, the display control unit 182 controls the text display unit 181 to display the identified confidential part and non-confidential part in different display aspects (step S702).

Subsequently; the confidential part change unit 183 determines whether or not the operation of changing the confidential part and the non-confidential part is performed (step S703). When the operation of changing the confidential part and the non-confidential part is not performed (step S703: NO), the subsequent steps may be omitted and a series of operation steps may be ended.

On the other hand, when the operation of changing the confidential part and the non-confidential part is performed (step S703: YES), the confidential part change unit 183 changes the confidential part and the non-confidential part in accordance with the operation content (step S704). After that, the change in the confidential part and the non-confidential part by the confidential part change unit 183 is reflected in the confidential target information (step S705). The change in the confidential part and the non-confidential part by the confidential part change unit 183 is also reflected in the display aspect of text in the text display unit 181, by the display control unit 182 (step S706).

### (Specific Examples of Display Aspect)

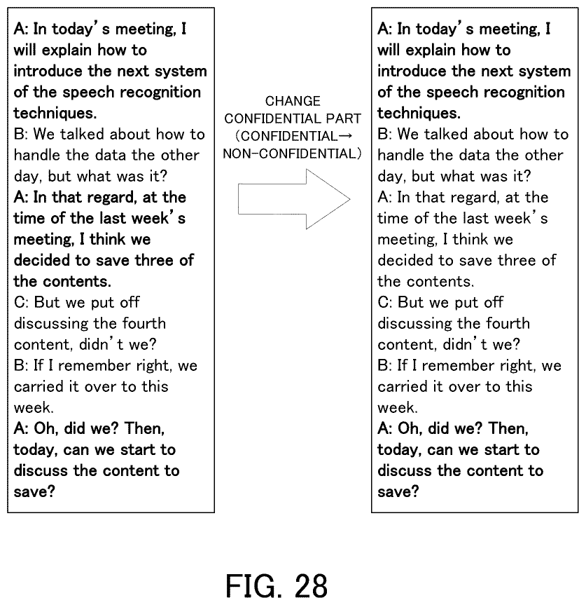

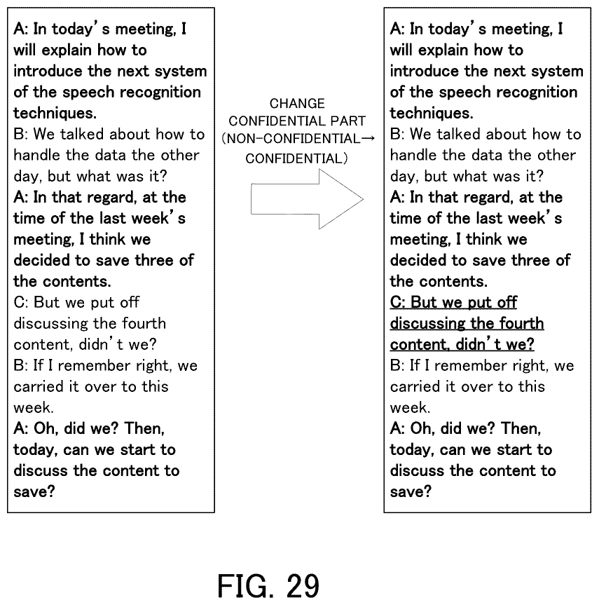

Next, specific examples of the display aspect in the confidential part change operation will be described with reference to FIG. 28 and FIG. 29. FIG. 28 is version 1 of a conceptual diagram illustrating an example of change in the display aspect by the information processing system according to the ninth example embodiment. FIG. 29 is version 2 of a conceptual diagram illustrating an example of change in the display aspect by the information processing system according to the ninth example embodiment.

In the example illustrated in FIG. 28, the confidential part is displayed in boldface and the non-confidential part is displayed in fine letters. Here, the content of speaking/utterance of the speaker A is identified as the confidential part, and the content of speaking/utterance of the speaker B and the speaker C is identified as the non-confidential part.

Here, a part of the confidential part is assumed to be changed to the non-confidential part. Specifically, the second speaking/utterance by the speaker A is assumed to be changed from the confidential part to the non-confidential part. In this case, the second speaking/utterance by the speaker A, which is previously displayed in boldface, is displayed in fine letters. As described above, the spot where the confidential part and the non-confidential part are changed, may be displayed in the same display aspect as that of the spot that is originally the confidential part or the non-confidential part.

In the example illustrated in FIG. 29, the confidential part is displayed in boldface and the non-confidential part is displayed in fine letters. As in the example in FIG. 28, the content of speaking/utterance of the speaker A is identified as the confidential part, and the content of speaking/utterance of the speaker B and the speaker C is identified as the non-confidential part.

Here, a part of the non-confidential part is assumed to be changed to the confidential part. Specifically, the speaking/utterance by the speaker C is assumed to be changed from the non-confidential part to the confidential part. In this case, the speaking/utterance by the speaker C, which is previously displayed in fine letters, is displayed in boldface with an underline. As described above, the spot where the confidential part and the non-confidential part are changed, may be displayed in a display aspect that allows a difference to be understood, in comparison with the spot that is originally the confidential part or the non-confidential part.

In the above-described examples, for convenience of description, the display aspect is distinguished by using the bold letters and the underline, but the display aspect may be distinguished by using color, a character size, a difference in font, other highlighting, or the like, for example.

### (Technical Effect)

Next, a technical effect obtained by the information processing system 10 according to the ninth example embodiment will be described.

As described in FIG. 26 to FIG. 29, in the information processing system 10 according to the ninth example embodiment, it is possible to change the confidential part and the non-confidential part in accordance with the operation by the speaker. In this way, it is possible to prevent the spot that does not need to be concealed, from being concealed. In addition, it is possible to prevent the spot that needs to be concealed, from being not concealed.

### Tenth Example Embodiment

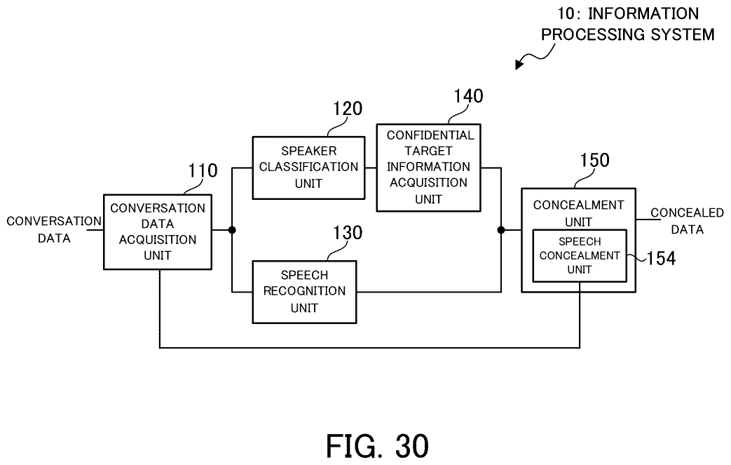

The information processing system 10 according to a tenth example embodiment will be described with reference to FIG. 30. The tenth example embodiment is partially different from the first to ninth example embodiments only in the configuration and operation, and may be the same as the first to ninth example embodiments in the other parts. For this reason, a part that is different from each of the example embodiments described above will be described in detail below, and a description of other overlapping parts will be omitted as appropriate.

### (Configuration and Operation)

First, with reference to FIG. 30, a functional configuration and operation of the information processing system 10 according to the tenth example embodiment will be described. FIG. 30 is a block diagram illustrating the functional configuration of the information processing system according to the tenth example embodiment. In FIG. 30, the same components illustrated in FIG. 4 carry the same reference numerals.

As illustrated in FIG. 30, the information processing system 10 according to the tenth example embodiment includes, as components for realizing the functions thereof, the conversation data acquisition unit 110, the speaker classification unit 120, the speech recognition unit 130, the confidential target information acquisition unit 140, and the concealment unit 150. In particular, the concealment unit 150 according to the tenth example embodiment includes a speech concealment unit 154.

The speech concealment unit 154 is configured to conceal a part of the speech information in the conversation data. More specifically, the speech concealment unit 154 may be configured to process the speech information by add a noise or the like to a part of the speech information in the conversation data, on the basis of the confidential target information, so that the speech/voice cannot be correctly heard. In this case, the confidential data includes the concealed speech data in addition to the concealed text data.

The above-described example embodiments may also be applied to the speech information that is concealed. For example, the concealment of the concealed speech information may be canceled by collating/verifying the biometric information.

### (Technical Effect)

Next, a technical effect obtained by the information processing system 10 according to the tenth example embodiment will be described.

As described with reference to FIG. 30, according to the information processing system 10 in the tenth example embodiment, it is possible to conceal the original conversation data (i.e., the speech information) as well as the textualized conversation data.

### Eleventh Example Embodiment

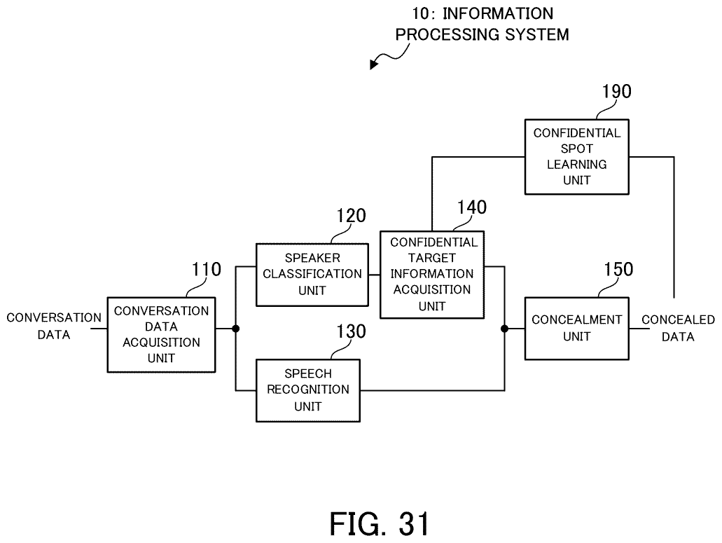

The information processing system 10 according to an eleventh example embodiment will be described with reference to FIG. 31. The eleventh example embodiment is partially different from the first to tenth example embodiments only in the configuration and operation, and may be the same as the first to tenth example embodiments in the other parts. For this reason, a part that is different from each of the example embodiments described above will be described in detail below, and a description of other overlapping parts will be omitted as appropriate.

### (Configuration and Operation)

First, with reference to FIG. 31, a functional configuration and operation of the information processing system 10 according to the eleventh example embodiment will be described. FIG. 31 is a block diagram illustrating the functional configuration of the information processing system according to the eleventh example embodiment. In FIG. 31, the same components as those illustrated in FIG. 4 carry the same reference numerals.

As illustrated in FIG. 31, the information processing system 10 according to the eleventh example embodiment includes, as components for realizing the functions thereof, the conversation data acquisition unit 110, the speaker classification unit 120, the speech recognition unit 130, the confidential target information acquisition unit 140, the concealment unit 150, and a confidential spot learning unit 190. That is, the information processing system 10 according to the eleventh example embodiment further includes the confidential spot learning unit 190 in addition to the configuration in the second example embodiment (see FIG. 4). The confidential spot learning unit 190 may be realized or implemented by the processor 11 (see FIG. 1), for example.

The confidential spot learning unit 190 is configured to perform learning about the confidential spot, with the confidential data (or the confidential target information) concealed in the past used as training data. Specifically, the confidential spot learning unit 190 is configured to perform learning for automatically determining what type of content of speaking/utterance should be concealed. The confidential spot learning unit 190 may include a neural network.

A learning result of the confidential spot learning unit 190 is used in the concealment operation after the learning. For example, in the concealment operation after the learning, the confidential target information may be automatically generated from the textualized conversation data, by using a learned model generated by the learning of the confidential spot learning unit 190.

### (Technical Effect)

Next, a technical effect obtained by the information processing system 10 according to the eleventh example embodiment will be described.

As described in FIG. 31, according to the information processing system 10 in the eleventh example embodiment, the learning about the confidential spot is performed, and it is thus possible to improve accuracy when automatically determining the confidential spot.

### Twelfth Example Embodiment

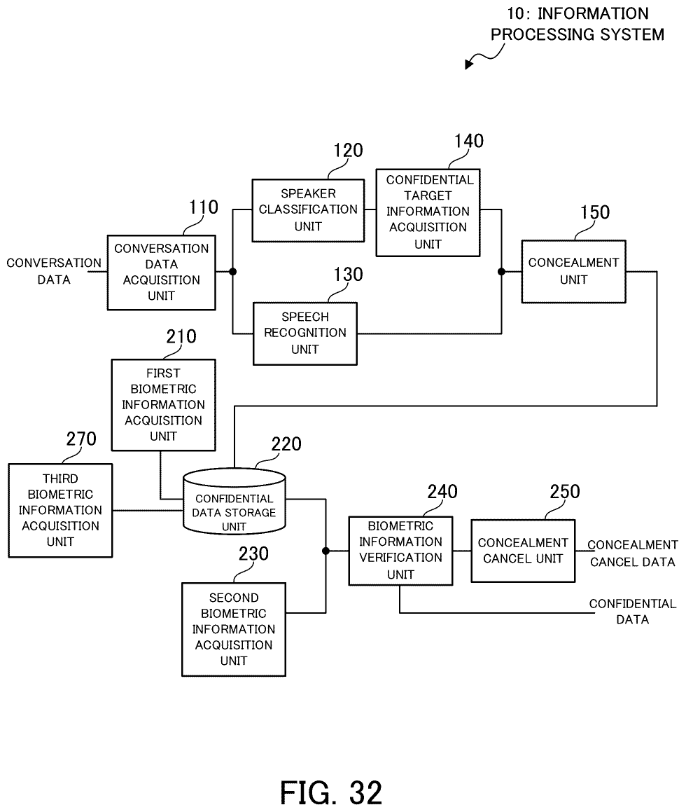

The information processing system 10 according to a twelfth example embodiment will be described with reference to FIG. 32. The twelfth example embodiment is partially different from the first to eleventh example embodiments only in the configuration and operation, and may be the same as the first to eleventh example embodiments in the other parts. For this reason, a part that is different from each of the example embodiments described above will be described in detail below; and a description of other overlapping parts will be omitted as appropriate.

### (Configuration and Operation)

First, with reference to FIG. 32, a functional configuration and operation of the information processing system 10 according to the twelfth example embodiment will be described. FIG. 32 is a block diagram illustrating the functional configuration of the information processing system according to the twelfth example embodiment. In FIG. 32, the same components as those illustrated in FIG. 11 carry the same reference numerals.

As illustrated in FIG. 32, the information processing system 10 according to the eleventh example embodiment includes, as components for realizing the functions thereof, the conversation data acquisition unit 110, the speaker classification unit 120, the speech recognition unit 130, the confidential target information acquisition unit 140, the concealment unit 150, the first biometric information acquisition unit 210, the confidential data storage unit 220, the second biometric information acquisition unit 230, the biometric information verification unit 240, the concealment cancel unit 250, and a third biometric information acquisition unit 270. That is, the information processing system 10 according to the twelfth example embodiment further includes the third biometric information acquisition unit 270 in addition to the configuration in the fourth example embodiment (see FIG. 11). The third biometric information acquisition unit 270 may be realized or implemented by the processor 11 (see FIG. 1), for example.

The third biometric information acquisition unit 270 is configured to obtain biometric information about a user other than the speaker who participates in the conversation (hereinafter referred to as “third biometric information” as appropriate). The third biometric information is different only in an acquisition target, but is substantially the same type of biometric information as the first biometric information. The third biometric information is obtained as biometric information about a user other than a speaker who wants to cancel the concealment. The third biometric information acquisition unit 270 outputs the obtained third biometric information to the confidential data storage unit 220.

The confidential data storage unit 220 associates and stores the third biometric information obtained by the third biometric information acquisition unit 270, with the conversation data (the confidential data) concealed by the concealment unit 150. That is, the confidential data are stored in association with the third biometric information obtained by the third biometric information acquisition unit 270, in addition to the first biometric information obtained by the first biometric information acquisition unit 210. The third biometric information stored in the confidential data storage unit 220 may be readable by the biometric information verification unit 240. That is, the third biometric information is stored as being used for the collation/verification with the second biometric information as well as the first biometric information.

When the collation/verification between the first biometric information and the second biometric information is failed, the biometric information verification unit 240 may perform the collation/verification between the third biometric information and the second biometric information. Then, when the collation/verification between the third biometric information and the second biometric information is successful, the concealment may be canceled by the concealment cancel unit 250.

### (Technical Effect)

Next, a technical effect obtained by the information processing system 10 according to the twelfth example embodiment will be described.

As described in FIG. 32, in the information processing system 10 according to the twelfth example embodiment, the third biometric information is obtained from the user other than the speaker who participates in the conversation. In this way, even the user other than the speaker who participates in the conversation may be able to release the concealment by the collation/verification using the third biometric information.

A processing method in which a program for allowing the configuration in each of the example embodiments to operate so as to realize the functions in each example embodiment is recorded on a recording medium, and in which the program recorded on the recording medium is read as a code and is executed on a computer, is also included in the scope of each of the example embodiments. That is, a computer-readable recording medium is also included in the range of each of the example embodiments. Not only the recording medium on which the above-described program is recorded, but also the program itself is also included in each example embodiment.

The recording medium to use may be, for example, a floppy disk (registered trademark), a hard disk, an optical disk, a magneto-optical disk, a CD-ROM, a magnetic tape, a nonvolatile memory card, or a ROM. Furthermore, not only the program that is recorded on the recording medium and executes processing alone, but also the program that operates on an OS and executes processing in cooperation with the functions of expansion boards and another software, is also included in the scope of each of the example embodiments. In addition, the program itself may be stored in a server, and a part or all of the program may be downloaded from the server to a user terminal.

### Supplementary Notes

The example embodiments described above may be further described as, but not limited to, the following Supplementary Notes below.

### (Supplementary Note 1)

An information processing system according to Supplementary Note 1 is an information processing system including: an acquisition unit that obtains conversation data including speech information on a plurality of people: a textualization unit that converts into text the speech information in the conversation data: a confidential information acquisition unit that obtains information about a confidential target included in the conversation data; and a concealment unit that conceals a part of text of the conversation data on the basis of the information about the confidential target.

### (Supplementary Note 2)

An information processing system according to Supplementary Note 2 is the information processing system according to Supplementary Note 1, further including: a first biometric information acquisition unit that obtains first biometric information that is biometric information about the plurality of people, while the plurality of people are speaking, from which the conversation data are originated: a second biometric information acquisition unit that obtains second biometric information that is biometric information about a user who uses the conversation data; and a cancel unit that collates/verifies the first biometric information with the second biometric information and cancels concealment on the basis of a result of the collation/verification.

### (Supplementary Note 3)

An information processing system according to Supplementary Note 3 is the information processing system according to Supplementary Note 2, wherein a concealment level is set in a spot concealed in the conversation data, a browse level is set for the user who uses the conversation data, and the cancel unit cancels the concealment of the spot of the concealment level corresponding to the browse level of the user who uses the conversation data.

### (Supplementary Note 4)

An information processing system according to Supplementary Note 4 is the information processing system according to any one of Supplementary Notes 1 to 3, further including: a classification unit that classifies the speech information in the conversation data for each speaker, wherein the information about the confidential target includes information indicating a word that is the confidential target, and the concealment unit conceals a part of the text of the conversation data for each speaker.

### (Supplementary Note 5)

An information processing system according to Supplementary Note 5 is the information processing system according to any one of Supplementary Notes 1 to 4, wherein the information about the confidential target includes information indicating a word that is the confidential target, and the concealment unit conceals a spot related to the word that is the confidential target included in the conversation data.

### (Supplementary Note 6)

An information processing system according to Supplementary Note 6 is the information processing system according to any one of Supplementary Notes 1 to 5, further including: a presentation unit that presents information encouraging at least one of the plurality of people, to input the information about the confidential target, after a conversation by the plurality of people is finished, wherein the confidential information acquisition unit obtains content inputted by the at least one of the plurality of people, as the information about the confidential target.

### (Supplementary Note 7)

An information processing system according to Supplementary Note 7 is the information processing system according to any one of Supplementary Notes 1 to 6, further including: a setting unit that sets a spot to be concealed in the conversation data, in accordance with content of operation by at least one of the plurality of operators, wherein the confidential information acquisition unit obtains information indicating the spot set by the setting unit, as the information about the confidential target.

### (Supplementary Note 8)

An information processing system according to Supplementary Note 8 is the information processing system according to any one of Supplementary Notes 1 to 7, further including: a display unit that follows a conversation by the plurality of people and displays the conversation data in text: a display control unit that controls the display unit to display a confidential part to be concealed by the concealment unit and a non-confidential part not to be concealed by the concealment unit, in different aspects; and a change unit that changes the confidential part to the non-confidential part in accordance with content of operation by at least one of the plurality of people.

### (Supplementary Note 9)

An information processing apparatus according to Supplementary Note 9 is an information processing apparatus including: an acquisition unit that obtains conversation data including speech information on a plurality of people: a textualization unit that converts into text the speech information in the conversation data: a confidential information acquisition unit that obtains information about a confidential target included in the conversation data; and a concealment unit that conceals a part of text of the conversation data on the basis of the information about the confidential target.

### (Supplementary Note 10)

An information processing method according to Supplementary Note 10 is an information processing method executed by at least one computer, the information processing method including: obtaining conversation data including speech information on a plurality of people; converting into text the speech information in the conversation data: obtaining information about a confidential target included in the conversation data; and concealing a part of text of the conversation data on the basis of the information about the confidential target.

### (Supplementary Note 11)

A recording medium according to Supplementary Note 10 is a recording medium on which a computer program that allows at least one computer to execute an information processing method is recorded, the information processing method including: obtaining conversation data including speech information on a plurality of people: converting into text the speech information in the conversation data: obtaining information about a confidential target included in the conversation data; and concealing a part of text of the conversation data on the basis of the information about the confidential target.

### (Supplementary Note 12)

A computer program according to Supplementary Note 12 is a computer program that allows at least one computer to execute an information processing method, the information processing method including: obtaining conversation data including speech information on a plurality of people: converting into text the speech information in the conversation data: obtaining information about a confidential target included in the conversation data; and concealing a part of text of the conversation data on the basis of the information about the confidential target.

This disclosure is not limited to the examples described above and is allowed to be changed, if desired, without departing from the essence or spirit of this disclosure which can be read from the claims and the entire specification. An information processing system, an information processing apparatus, an information processing method and a recording medium with such changes are also intended to be within the technical scope of this disclosure.

### DESCRIPTION OF REFERENCE CODES

10 Information processing system
11 Processor
110 Conversation data acquisition unit
120 Speaker classification unit
130 Speech recognition unit
140 Confidential target information acquisition unit
150 Concealment unit
151 Concealment level setting unit
152 Word search unit
153 Word concealment unit
154 Speech concealment unit
161 Proposal information presentation unit
162 Input reception unit
171 Operation input unit
172 Confidential spot setting unit
181 Text display unit
182 Display control unit
183 Confidential part change unit
190 Confidential spot learning unit
210 First biometric information acquisition unit
220 Confidential data storage unit
230 Second biometric information acquisition unit
240 Biometric information verification unit
250 Concealment cancel unit
260 Browse level acquisition unit
270 Third biometric information acquisition unit

What is claimed is:

1. An information processing system comprising:
at least one memory that is configured to store instructions; and
at least one processor that is configured to execute the instructions to:
obtain conversation data including speech information on a plurality of people;
convert into text the speech information in the conversation data;
obtain information about a confidential target included in the conversation data; and
conceal a part of text of the conversation data on the basis of the information about the confidential target.

2. The information processing system according to claim 1, wherein the at least one processor is configured to execute the instructions to:
obtain first biometric information that is biometric information about the plurality of people, while the plurality of people are speaking, from which the conversation data are originated;
obtain second biometric information that is biometric information about a user who uses the conversation data; and
collate/verify the first biometric information with the second biometric information and cancels concealment on the basis of a result of the collation/verification.

3. The information processing system according to claim 2, wherein
a concealment level is set in a spot concealed in the conversation data,
a browse level is set for the user who uses the conversation data, and
the at least one processor is configured to execute the instructions to cancel the concealment of the spot of the concealment level corresponding to the browse level of the user who uses the conversation data.

4. The information processing system according to claim 1, wherein
the at least one processor is configured to execute the instructions to:
classify the speech information in the conversation data for each speaker,
the information about the confidential target includes information indicating a word that is the confidential target, and
the at least one processor is configured to execute the instructions to conceal a part of the text of the conversation data for each speaker.

5. The information processing system according to claim 1, wherein
the information about the confidential target includes information indicating a word that is the confidential target, and
the at least one processor is configured to execute the instructions to conceal a spot related to the word that is the confidential target included in the conversation data.

6. The information processing system according to claim 1, wherein the at least one processor is configured to execute the instructions to:
present information encouraging at least one of the plurality of people, to input the information about the confidential target, after a conversation by the plurality of people is finished, and
obtain content inputted by the at least one of the plurality of people, as the information about the confidential target.

7. The information processing system according to claim 1, wherein the at least one processor is configured to execute the instructions to:
set a spot to be concealed in the conversation data, in accordance with content of operation by at least one of the plurality of operators, and
obtain information indicating the spot set, as the information about the confidential target.

8. The information processing system according to claim 1, wherein the at least one processor is configured to execute the instructions to:
follow a conversation by the plurality of people and display the conversation data in text;
display a confidential part to be concealed and a non-confidential part not to be concealed, in different aspects; and
change the confidential part to the non-confidential part in accordance with content of operation by at least one of the plurality of people.

9. (canceled)

10. An information processing method executed by at least one computer,
the information processing method comprising:
obtaining conversation data including speech information on a plurality of people;
converting into text the speech information in the conversation data;
obtaining information about a confidential target included in the conversation data; and
concealing a part of text of the conversation data on the basis of the information about the confidential target.

11. A non-transitory recording medium on which a computer program that allows at least one computer to execute an information processing method is recorded,
the information processing method including:
obtaining conversation data including speech information on a plurality of people;
converting into text the speech information in the conversation data;
obtaining information about a confidential target included in the conversation data; and
concealing a part of text of the conversation data on the basis of the information about the confidential target.
